(19) United States
(12) Patent Application Publication
(10) Pub. No.: US 2025/0381734 A1
(43) Pub. Date: Dec. 18, 2025

(54) Additive Manufacturing Platform, Resin, and Improvements for Microdevice Fabrication

(71) Applicant: Skyphos Industries Inc., Blacksburg, VA (US)

(72) Inventor: Walter Elliot McAllister, Blacksburg, VA (US)

(21) Appl. No.: 18/742,631

(22) Filed: Jun. 13, 2024

(51) Int. Cl. B29C 64/277; B29C 64/129; B29C 64/232; B29C 64/286; B29C 64/393; B33Y 10/00; B33Y 30/00; B33Y 50/02

(52) U.S. Cl. CPC B29C 64/277; B29C 64/129; B29C 64/232; B29C 64/286; B29C 64/393; B33Y 10/00; B33Y 30/00; B33Y 50/02

(57) ABSTRACT

A three-dimensional printer (3DP) or 3D printing system, including additive manufacturing (AM) systems, employing multiple bandgaps and/or multiple spectrums/multiple wavelengths to enable a controlled vertical cure-depth/polymerization via photoinitiator activation of a singular resin composition for high definition micro-printing at an accelerated rate. The invention enables a dynamic range of layers 10-1000× for macro and micro features. This in turn enables faster printing speeds without fidelity and tolerance losses typically experienced. The system of resin, a 3D printing platform, and accompanying computer controlled algorithms, can be used for the fabrication and creation of macro and microdevices via a wide range of ultraviolet photoinitiated materials.

### CROSS-REFERENCE TO RELATED APPLICATIONS

This application is a continuation of U.S. patent application Ser. No. 17/943,177, filed Sep. 12, 2022, which is a continuation-in-part of U.S. patent application Ser. No. 17/277,540, filed on Mar. 18, 2021, which is now U.S. Pat. No. 11,442,345, which claims priority to PCT/US2019/051797, filed Sep. 18, 2019, which relies on the disclosures of and claims priority to and the benefit of the filing date of U.S. Provisional Application No. 62/732,841, filed Sep. 18, 2018. The disclosures of those applications are hereby incorporated by reference herein in their entirety.

### BACKGROUND

### Field of the Invention

3D Printing (3DP), Additive Manufacturing (AM), microdevices, Microfluidics (uF), Point of Care Diagnostics (POC), and Lab on a Chip (LOC):

Three-dimensional (“3D”) printing (or “3DP”) is disruptive to standard manufacturing. A well attenuated 3D printer directed at a particular and focused manufacturing area has displaced well-entrenched manufacturing processes previously. For example, from 2014 to 2016, Phonak was the first to employ 3D printing to produce hearing aid, which until that point were traditionally produced via molds. The success and speed Phonak experienced resulted in the entire hearing-aid industry replacing the mold-based fabrication methods it had relied on for decades and adopting 3D printing. According to the article in the Harvard Business Review (see, https://hbr.org/2015/05/the-3-d-printing-revolution), there were three market factors that drove this change:
1. Hearing Aids require high tolerances for a custom fit in the patient ear, 3D printing was finally able to meet these requirements;
2. The number of parts per design (or mold) was either low-volume or custom-made; and
3. Speed: Due to the device scale, 3D printing was equal to or faster than mold-based fabrication.
   In short, 3D printing suddenly became more economical for the manufacturer than the decades-old mold-based methods.

3D printing is of interest in the development and mass fabrication of microdevices and microfluidics (uF). These technologies are typically used in biosensors, diagnostics, sensors, Lab on a Chip (LOC), or mimics of organic systems, oil and gas, agriculture, animal husbandry, as well as human healthcare (e.g., genomics, proteomics, and phenotyping, etc.). They are used to investigate and further the understanding of key chemical processes. These methods can offer significant cost and time savings, offer new actionable information, and have been heralded for their potential to revolutionize patient care including remote healthcare and infrastructure, bioreactor/tissue fabrication, organ regeneration, and biomedical applications in a home, clinic, or hospital setting. However, to date, uF and other associated technologies have hit a prototyping and fabrication roadblock due to their intrinsic reliance on semiconductor fabrication methods which adds prohibitive costs and timelines greater than one year for prototyping. Until very recently, 3D printing systems have been unable to combine both the feature sizes required (e.g., <100 um) with the larger print scales needed to pack all components on a device (e.g., 30-70 mm), and the integration of chip-to-world connectivity.

Generally, 3DP is thought to be a slower process than mass fabrication like molding. It is seen as a bridge to manufacturing and is mainly used for rapid prototyping or small batches for initial product development. However, as shown herein, the Skyphos developed 3DP (Infini-3D) according to the invention described herein, can challenge the current paradigm because, in the correct application (based on quantity and scale of parts), the current invention is both a product development accelerator and a flexible/agile manufacturing platform. As applied to the unique requirements of micro-parts like uF, the Skyphos AM/3DP systems according to the invention(s) described herein surpass the current manufacturing methods at all stages of the product lifecycle.

### Description of Related Art

3D printing or additive manufacturing (AM) is a known manufacturing process. Generally, to produce a solid model, a 3D CAD model of an object is sliced into layers via slicing software, with each layer being the same thickness as all others. This thickness defined by the user, usually between 20 um and 100 ums. Layers are then sequentially printed in order and totality to create a solid model in the physical world, generally taking the same time per layer. There are several types, the current invention in embodiments focuses on vat-based, which includes digital-light projection (DLP), laser-based stereo-lithography (SLA/MSLA) and LED/LCD based, and 2-photon-polymerization, all of which use resins which have a reactive photo-initiator to initiate and create polymerization, changing the resin from liquid to solid. In this process, once the image projection is complete for a layer and polymerization has occurred, the stage/elevator will move to a position sufficient to allow the unpolymerized resin to flow back in and then return to a position for the next layer. This continues, one after another until the model is complete. At the end of a print, the devices are removed from the printer and build plate, washed with IPA or suitable solvent, and any open channels or areas where resin remains flushed. The parts are allowed to dry and a final cure in a UV oven occurs.

### Fused Deposition Modeling (FDM) Printer:

Most people first become familiar with 3D printing through FDM machines that use thermoplastics, which are flowable at elevated temperatures and reform after cooling. An example is Dolomite micro-Fluidics™, which devised a 3D FDM printer with specialized algorithms for FDM style printers. Their main focus was the proper sealing of one layer to the next, as FDM devices are notoriously prone to leaks and micro-voids. Typical materials include polylactic acid (PLA), Polyethylene Glycol (PEG), and ABS. The raw materials arrive to the printer initially formed into thin filaments and wound on a spool. The filaments are heated and pushed through a nozzle with a small outlet in the 0.1-0.5 mm range. The plastic is extruded into a pattern for each layer of a 3D print. The resolution of features and objects is governed by tuning the layer height to a cross-section of the nozzle and the extruded shape of the polymer as it is compressed into the layer or line raster. In general, the smallest line these machines are capable of ranges between the actual cross-section of the nozzle and a multiplier number greater than 1 and less than 2 (i.e., a 0.5 mm nozzle can produce lines between 0.5 mm and 1 mm). FDM printers do have easily accessible biocompatible materials. An example of an FDM printer for use in microfluidic devices is the Dolomite Fluidic Factory™. The main issue with FDM technologies is the resolution precludes it from truly uF size range (>0.5 mm). Second, by the nature of extruded layers and lines, parts created by FDM methods are porous, and it is difficult to ensure all layers are sealed and bonding throughout. Thus, this existing process has issues with pockets where microbes and biological targets are being caught or leached into other areas.

Liquid or Resin-Based Printer (Vat Style): Resin-based printers have two main orientations, top-down or bottom-up. These nomenclatures indicate the direction of a light source to the build area or platform. In this style of printer, a liquid resin comprised of one or more monomer(s) and/or oligomer(s), sometimes with plasticizers; a suitable photo-initiator that reacts with the light source of the printer. The resin also includes (usually) a photo-blocker (“PB”) and/or dye which are used to limit the cure depth (penetration in Z) of the light source. The PB also acts to reduce “over-cure” or bleeding over (beyond the illuminated area in XY) to reduce unwanted polymerization in previously printed layers, especially channels that are to remain open in the final part. After completion, the part is considered in a “green-cure” state, meaning it has structure but not final strength and has residual unreacted resin components. Finishing is completed by washing the green-cure in a proper solution bath such as Isopropanol (IPA) to remove residual resin from the surfaces, flushing channels, and using a final cure step placing the model in a UV chamber, sometimes with heat, to bring the strength up and eliminate any toxic remnants of resin, photoinitator(s), photoblocker(s), and/or monomers, which, in the case of biomedical components, can kill target cells or be dangerous to handling.

There are 4 main derivatives of resin-style printers: LCD, stereolithography (SLA), two-photon-polymerization (2PP), LED-DLP, and Projector-DLP. The major difference between each is a method of illumination used to create the polymerization reaction. All previous derivatives except for the projector-based DLP and 2PP printers use what is considered a “single source” light-either an LED array or laser, both of which have very definitive and narrow bandwidths. 2PP and DLP are discussed in more detail below but, in the case of 2pp, use a sub-light particle, and DLP and projector-based machines typically use a standard Mercury bulb which has a wide spectrum from approximately 325 nm through visual and into the IR spectrum. Generally speaking, the light source for the non-projector-based machines lies within the UV regime and are single channel UV arrays to prevent them from reacting during normal handling around a lighted room using a PI within the visible light spectrum, which would result in polymerization (though there are exceptions that have portions in the visible light spectrum like Igracure819). Typical single channels LEDs and lasers are 10-20 nm wide and centered at 365, 375, 385, 395, 405 nm, etc., but note that LCD machines cannot readily use lower than 405 nm because the transmittance of the LCD screen drops to nearly 0% below 385 nm.

### SLA-Printers:

The invention(s) as described herein focus on Vat-based printers. For example, FORM Labs 2 and 3 have a laser cross-section approaching 70 um and many LCD printers have pixel resolutions between 20-50 um. The resulting features have minimal cross sections of approximately 150 um for solids and voids of 250-750 um however they cannot print features or enclosed channels below this threshold. SLA styles of 3d printers are unique in that they raster or trace a laser to the surface, and as such do not have pixel artifacts found in DMD/LCD which looks like steps or the serrations of corners on a diagonal. Channels need to be smooth with low surface roughness for microfluidics, so DLP style printers when operating near the limit of resolutions use “antialiasing” methods. Anti-aliasing is the blending of pixel transitions between black and white, or numbers 0-255 in graphic rendering.

### Bottom-Up Printer:

In a bottom-up printer, the light source is below the resin and projected through a window to cure the resin; LCD, DLP, SLA printers all have versions of this style. During the printing, between each layer, the build platform is raised a small distance in Z in a “peel-step.” This is required between each layer to detach the cured material from the bottom of the vat and allow the uncured new resin to fill back in. Most bottom-up printers like LCD and DLP cure the entire layer at once, eliminating the longer process or rastering across the entire layer until the beginning of the next. SLA printers use the laser incident spot and trace the design using a rastering motion like FDM printers to fill, much like a crayon colors in between the lines.

The motion of the elevator in Z, or the peel-step between each layer adds to the time it takes per layer. After curing or printing the layer, the elevator will raise up a certain height, usually around 5 mm to allow the liquid resin to backfill under the elevator and the previously printed layer. After allowing suitable time the elevator will return to the position for the next layer to be printed. In many cases, the curing step takes 2-10 seconds per layer and the peel-step adds 15-30 seconds more-in some cases more time than the polymerization itself.

As the peel-step is mechanical, serving only to refresh the exact amount of resin needed in the areas required for the next layer and it can take a longer time than curing a single layer, it would be advantageous if one could eliminate or shorten the peel and exposure times to increase the build speed.

Beyond the peel step and resin viscosity, the size limitation is set by or heavily influenced by the absolute minimal pixel aspect. A pixel, or laser cross section-in the case of FORM Labs, is the minimal size one could hope to print. The pixel is the individual atom, building block, or LEGO in creating a surface or 3D image. The minimal size of a pixel and those artifacts/features are limited by the wavelength they employ to create a solid. The use of Extreme UV (EUV) vs. Deep UV (DUV) in lithography teaches this-smaller wavelengths can create smaller artifacts or features.

In typical DLP printers from companies like Asiga™ and others, the minimal cross section of a pixel as incident on the polymerization zone is around 20 um and uses a wavelength of 385-405 nm. It is claimed 27-32 um in the case of Asiga™ (DLP) and 22 um in the case of Phrozen™ micro-8K (LCD). In literature, such as from Nordin from BYU and others, it has found that the minimal cross section to be created (solid of void) is about 3-5x the minimal pixel cross section. In the practice at Skyphos, the current Applicant, and according to the current invention as described herein, it has been found that this is generally true, but in applications according to the current invention, the system is able to print to 1 pixel wide channels that are open topped. 3 Pixels for a DLP and 4-5 for an LCD are required in some cases to elicit a solid/void in a closed channel configuration. However, there is another phenomenon, the difference between DLP and LCD that also can be important.

Because of the physical structure of the LCD pixels vs. DMD mirrors, the LCD pixels create chasms between them unlike the DLP structures. These chasms create issues for nanoparticles which become entrapped as they are flowing down the channels. It is preferred that the channels are as smooth as possible. LCD cannot provide the necessary surface smoothness required for microfluidics.

### Continuous Liquid Interface Production (CLIP):

This technology was specifically developed to eliminate the peel-step, which takes considerable time and can introduce layering effects that look like steps and increase surface roughness. In CLIP, an oxygen-permeable material is used in place of standard materials. This allows oxygen present in the environment to penetrate the membrane and saturate a thin layer of resin just above. As oxygen is an inhibitor to the curing process, it creates a small buffer thickness of resin which is resistant to polymerization. The window is still transparent to UV light which polymerizes the resin except for that small thin layer of resin. Above this layer, the bulk resin in the vat does not have a significant content of dispersed 02. This bulk resin is in contact with the elevator or previous layers. This allows a bottom-up printer to function without the peel-step. By moving slowly, and essentially drawing the resin up from the bottom in one continuous motion the pixels are changed between layers, like a movie, and use grayscale to enhance the cure tolerances.

However, this process is influenced and limited by the viscosity of the resin—the higher the viscosity and the larger the area cured means it will take longer for the resin to move into and refill the area of the last layer. CLIP technology is also cost-prohibitive. CLIP claims to be 25-100× faster than other printers, but in reality, when compared to other bottom-up DLP styles it is about 1.5-6× faster. This advantage is eliminated in open-source printers systems like Gizmodo™ which are “top-down” and have an open tank with oxygen present naturally from the atmosphere; they can print at the same speed.

### Top-Down Printer:

Top-Down printers cure resin via a light source above the vat which is focused on the upper surface of liquid resin. As each layer is printed, the build platform is lowered into the resin vat sequentially after each step/layer or in one continuous motion. In one example, Gizmodo™ out of Australia, uses continuous light exposure in a video clip to cure the resin with no layer lines present. An advantage exists in that there is no need to introduce O₂ permeable membrane layers as the chamber contains natural O₂ at atmospheric pressure which slows or retards the polymerization. The overall detractor to this style of printer is that the vat must be tall enough to enclose the entire height of the object to be printed. In some cases, manufacturers, like Boston Micro Fabrication™ (BMF), found that they needed to use a membrane and roller due to the slow backfill of thicker viscous resins and maintain projector focus on the surface to maintain tolerances for microdevices due. This membrane prohibits the above advantages as it is not oxygen permeable. Outside of specialized optics and far-field lenses, the current limitation for resolution produced by both printer styles are limited to pixel size.

### LCD:

Like a visual solenoid, a Liquid Crystal Display (LCD) uses voltage to “open” or “close” pixels on a transparent section of thin glass. The passage of light via pixels that alternate between black (eliminating light) and clear (allowing light transmission) when switched between energized or not. An LED array below the LCD screen passes light to the resin in the specific areas to be polymerized only when the pixel affecting that area is open/clear. Beyond being cheap to manufacture, the advantage here is that a pure light source or diode laser source can be chosen to precisely fit the combination of PI/PB selected. However, there are two major drawbacks to LED/LCD setups. The smallest pixel for LCDs is currently 22 um (Phrozen™), as mentioned previously, approximately 3-5 pixels in width are required to form an open channel, the smallest able to be created are about 150 ums. Microfluidic devices require features and enclosed channels in the 5-120 um range, so this precludes these 3D printer systems from use in true microfluidics. Further to this point, LCDs will be difficult to shrink much below this segment because there is a physical device needed to create the open/closed pixel requiring switching, electronic connections, etc. (See, https://en.wikipedia.org/wiki/Liquid-crystal_display#:˜:text=A%20liquid%2Dcrystal%20display%20(LCD,images%20in%20color%20or%20monochrome.) Second, the light sources which can be used are limited. LCD screens, in the open position, transmit only about 6-8% of the light at 405 nm, and about 2-4% for 385 and ˜0% below that, they are not transparent to all wavelengths. Most biocompatible and clear resins use PIs at 385 and 365 and even down to 325. Further confounding the issue is the surface roughness for LED/LCD machines which is generally too high for uF use in practice.

micro-DLP—micro-SLA:

Current technology from BMF™, Acres™, etc. employ extremely high-powered and expensive parts which cost 10-100× more than a standard a projector that can be purchased from Amazon™; for example, a microscope objective (Vidascope™) along with a DLP projector kit from Texas Instruments™. The light engines for these machines are based on a single LED array of 365 nm or 385 nm in the case of Nordin/Acrea, and 405 nm in the that of BMF/Fang. Generally, these platforms are limited by focusing optics, aberrations in the lens, and the DeBye number (½ the wavelength used for polymerization). The smallest resolution claimed so far is ˜2 um through the use of far-field technology by BMF and the Nick Fang group originating from MIT. The machines use a custom set of optics and provide only one resolution setting or size, this limits the adaptability and applicability of the printer to a particular scale-micro. Because the DMD mirror array has a certain number of pixels—as these pixels are reduced in size to hit a resolution, so too is the total XY area of the system. Unfortunately, these systems do not have the latest DMD sets available due to expense and small market for DMDs.

As to Z motion, micro-printing systems employ either a set of stepper motors and lead-screws with matched linear rails or a nano-resolution stage from suppliers like Thor™, Edmunds™, or Pi-USA™, thus the base cost for materials on these machines is near $70k-$100k prior to any software development or machine translation for staging and repeat movements.

While DIY 3D printer kits were available up until about 2015, the attempt to use additional optics on the outside of the projector and after the final lens to shrink the pixel aspect remains at a minimum of 18-20 um, this is still not acceptable for the 1-10 um preferred and required for uFluidics. Further, these lenses introduce aberrations and distortions in the print which preclude them from use in high tolerance parts.

### 2-Photon-Polymerization:

This technology uses sub-light particles and is capable of producing feature sizes below 100 nm and into the macro range. While expensive at $200k or more, their advantage beyond feature size is that they can produce devices and features truly within the nano to microscale.

While it is impressive to reduce the size of the pixel, this effort introduces another limitation: a set of exceedingly small resolutions means much longer print times. Small pixels mean each part, feature, and layer-whether needing that size resolution for features or not-will be printed with that size. 2 um vs. 20 um resolution means a 100× penalty in the number of moves and exposures (X multiplied by Y). If each move requires 10 seconds to move the projector to a new position, this means 1000 seconds per layer is spent just moving to the extra positions. At 10-second exposures per layer, it is another 1000 seconds, meaning it requires 2000 seconds extra seconds per layer. At 100 layers, it would take over 16.5 hours longer to print the higher resolution device vs. 30 minutes to produce the one with lower resolution. Most microfluidic devices using these printers would take around 8-18 hours to print a single device, ergo it is not a mass fabrication method.

While they excel at features in 3D, the time it takes to complete one part is a problem. In a manufacturing environment to enable the fabrication of 100's to 1000's of devices per day, the scale-up for the number of machines is unrealistic, the machines are too expensive, slow, and take highly trained individuals to operate.

Speed is a factor that needs to be considered. If 3D printing is to compete against mass fabrication, it would need to beat cycle times of 15 minutes for hot-embossing, and the 3-90 seconds (per layer) of injection molding. This would be a welcome addition for providing rapid prints with the ability to resolve any features. In fact, comparing the timelines of a 3DP moving from drawing to part, as opposed to a drawing, mask, device layer, and assembly it is faster.

### A Final Note on 3D Printing Manufacturers Specifications for Resolution:

The resolution and minimal feature size for SLA is controlled by the gaussian laser cross-section as it impacts the vat (usually considered at FWHM). In the case of DMD-based and LCD screens, the size of the pixels in X and Y as they are displayed on the actual build plate is known as “pixel pitch.” Generally, it is accepted that the minimum feature size is near 4-5× the pixel or laser width, and the minimal void possible is about 3-4× pixel size for DLP and 4-6× for LCD (though with high surface roughness). Often, the minimal pixel aspect is incorrectly referred to as resolution for feature sizes in marketing materials; taken this way, a manufacturer's specifications for minimal feature sizes are incorrect.

The science of microfluidics requires devices with smooth walls and tight tolerances for channels and artifacts close to the single micron size range. To perform the development of these devices, researchers would require pixels in the range of 500 nm-10 um. Most DLP projectors hit a lower limit between 20-50 um in pixel pitch, resulting in a resolution of a solid feature or open channel close to 100 ums. In the cases where needed feature sizes are close to or below a proper size, the printer will generate not smooth lines but a pixelated image.

As stated previously, these systems are limited in that the build area per layer is directly tied to the minimum feature sizes (pixel aspects) innately tied to the DMD; smaller pixels mean smaller build areas. According to the mathematics, a 10-um pixel with a 4K (3840 × 2160) pixel can only produce a 38.4×21.6 mm device, and a 20 um pixel on the same DMD can produce a device at 76.8×43.2 mm. This illustrates the problem to create objects of a usable size because most LOC devices require upwards of 25×75 mm area prints, but to create most of the features requires pixels between 1-5 um and a speculated maximum of 10 ums. Currently, it appears that no 8K micro-DLP printer exists.

Attempts have been made to address the minimal pixel aspect needed, but improvements are needed due to common issues noted above and herein, which can be addressed by the current invention described herein.

### Next Generation Printer Needs:

The previous offerings of 3D printing systems have not yet attained the ability to complete the four tasks required of devices: (1) needed resolutions (1-10 um), (2) producing surface quality with roughness at or below 1 um, (3) biocompatible resin, which is also clear and low-auto fluorescence, and (4) a printer which can enact a large enough printable area (75×75 mm).

Improvements need to be developed to overcome the noted limitations, and the current invention described herein presents several innovations to enable this ability.

### Microfluidics and Microdevices:

For more than three decades the fabrication of uF devices and their disciples has relied on semiconductor technology, Si-wafer fabrication, and lithographic methods re-appropriated from the industry to create molds. The method of fabrication via molds to make individual layers and then assembling/stacking layers has limited gains as the complexity increases while having a lower success rate due to device failure. These limits mean device construction requires well educated operators, hundreds of steps, and a clean room to convert the mold to a working prototype. Oftentimes results from devices made by different operators are inconsistent even though all are highly trained. The time and expense have placed the burden of prototyping and production of these devices/breakthroughs onto the hands of researchers, creating a need for incredible expertise and infrastructure. Additional technology for prototyping through fabrication and new capabilities for this burgeoning area of research has been relatively stagnant over this same period of time because all progress is tethered to incremental improvements for both the materials and the fabrication methods from an industry that is focused on electronic and memory applications for computers and circuits as opposed to biology-based.

This limiting fabrication process means that ideas can take upwards of 6 months to turn into prototypes, the process is exceedingly expensive—with costs upwards of $10k for a single prototype. Therefore, a need exists for a new method of manufacturing, from prototype through production-to create smaller feature sizes with high surface quality to enable the fabrication of high-tolerance components including medical device components, microfluidic devices, and their components such as Lab on A Chip (LOAC), Micro-Electro-Mechanical Systems (MEMS), highly complex manifolds and connectors, and some experimental components such as pipette tips, syringe tips, optical waveguides.

Problematic customer experiences with current 3DP technology compared to the requirements for the functioning platform and process are distilled below. They include but are not limited to:
Surface roughness (<1 um)
Optical clarity (clear, non-colored)
Minimal feature size (1-100 um)
Enclosed channels (<100 um, prefer <50 um)
Overall device size (20-100 mm)

Limitations in the current field include but are not limited to speed, post-processing, overall build size, and cost for expertise and underlying machine. Further, because printers rely on a single light channel, bandwidth, or wavelength-usually via an LED array-they can also be limited to the number of compatible resins with the light-source. Accordingly, a long-felt need exists for improvements to the current state-of-the-art technology for 3D microprinting.

Related art includes:

U.S. Patent Publication number 2021/0009408, which teaches using one type of light spectrum from an LED array. This teaching has limitations in regard to cure depth, green-cure, or green cure, that are improved upon with the current invention.

U.S. Patent Publication No. 2017/0057162 refers to a micro3DP method but teaches the use of far-lenses which enable features below the Bragg-Limit of ½ wavelength (e.g., far-field lens optics and technology). However, limits to change resolution or depth of cure are improved upon by the current invention.

U.S. Pat. No. 9,574,039 teaches, e.g., using two different photo-initiators to allow curing after green state. Toxicity issues that could result from that reference are improved upon by the current invention.

### SUMMARY OF THE INVENTION

In embodiments, the current invention provides a 3D printing platform, such as a complete platform, allowing for 3D printing of microdevices for applications in microfluidics, LOAC, POC-diagnostics, drug discovery, custom liquid handling, as well as for applications having comparable size requirements or micro-features, such as cross-technology to MEMS and optical waveguides. It can include resin, a computer processor for calculations and programming based on, e.g., predetermined parameters, a light engine or projector or home entertainment projector based on a standard projector bulb, laser or LED/multiple wavelength LED Array, and/or motors with automated mechatronics. As used herein, a light engine or light source from a projector can be used interchangeably, and can also include a source of irradiation. A light engine can be used to refer to a light source from one or more projectors. In cases, a light engine or light source can be used to refer to any source of light, light radiation, radiation, and/or radiation with the intent to polymerize a liquid to a solid, or light activated polymerization, referred to herein and as would be understood by one of ordinary skill in the art.

The invention described herein enables, in embodiments, new features, by way of example only, decoupling pixel and ultimate feature resolution from a static set of pixels, increasing the maximum working cross-section (XY) in galvo LCD and DLP based 3D systems, and allowing for sub-pixel resolutions on LCD/DLP based machines, such as, in aspects, via mechanics and software to enable these style machines to emulate a laser galvanometer-based system.

In embodiments of the invention described herein, the invention allows for production of parts at a rate fast enough to complete at 1-2 minutes per device, or with a folding device for 5-15 minutes. These are non-limiting examples only.

A microdevice or microfluidic device can comprise a series of interconnected channels or voids and solid geometries; in some embodiments the microdevice or microfluidic device has aspects under 1000 um.

The general and accepted process of 3D printing is defined as a layer-by-layer process—wherein each layer is the same thickness as the preceding—meaning all layers are the same. According to the current invention, it allows different, sometimes substantially different, layer heights (e.g., approaching 100× differences between each, such as 10 um vs 1 mm). Skyphos has termed this attribute “dynamic printing speed”, “dynamic layering”, or “dynamic layer height”, or “dynamic print height”. In addition, the current inventions allows for the use of individually addressable pixels, groups of pixels from one exposure, multiple groups from a moving projector, and areas of single, intermixed, and independent layers, for custom cross-linking and interior surface roughness of channels and sections of those channels.

In aspects, this invention includes the creation of this 3D printer or additive manufacturing (AM) platform and resin formulation for the purpose of creating microfluidic and microdevices via layer by layer and voxel by voxel method(s). The process/system can display pixels on the polymerization surface at sizes between 0.1 and 100 ums (microns) with a DLP projector which uses a wide spectrum bulb (such as NMHi, metal-halide bulb, Hg, or one or more bank of several different wavelength LED bulbs, or UV to visible light, or multi-wavelength source, or multi-laser source, or combination thereof). In aspects, it can utilize a filter set to attenuate the bandwidth reaching the working polymerization layer (the layer between the top of the vat window and the bottom of the elevator/stage/glass slide). The bandwidth (range of optical frequencies by non-limiting example, 190 nm to 425 nm), being controlled in aspects by the bandwidths of the optical light filter set, tunes the cure depth for a given segment (in Z) of the solid being created. The light source can be targeted and focused using an apparatus as described in U.S. patent application Ser. No. 17/277,540, filed on Mar. 18, 2021, as incorporated by reference herein. Further, the current invention allows for use of a gantry system to take advantage of temporal areas of displayed pixels emulating and enhancing the methods of SLA-style printing.

In aspects, because of the nature of devices and size requirements, the current inventive printing system can offer advantages/improvements over the current state of manufacturing hot embossing and injection molding. By way of example, the typical limit for the number of assembled layers in mold-based uF is approximately 3-layers and has a 50%-80% failure rate, with an 8-hour cycle assembly time at a total height of 4 mm. According to the present invention, in examples, 3D printing can create a 22-layered device, with over 100 inlets and outlets, a 1.5 mm height, and takes 14 minutes to produce with a 90% pass rate; it can be direct from drawing to part, and does not require months waiting for a mold. This is faster when compared to semiconductor technologies which rely on molds that require two-month lead times, for example, or hot embossing which typically takes 12-45 per layer minutes for the same size and resolutions and has a 6-12 month lead time for just the molds and not any processing time for cleaning, set-up, etc.

Microfluidics are typically devices such as a small cassette, cartridge, or “chip,” varying in size from 1×1×5 mm up to 500×100×75 mm with notable features and designs both internal and external to said chip, such as channels, walls, pillars, valves, openings, vias (vertical channels), wall thicknesses or membranes, fluid passages, fluid reservoirs, reactant reservoirs, hollow passages (which may or may not be backfilled with solids, liquids, gels, or phase-changing matter), and other aspects of the notable features range in size typically set by the targets being studied, which usually falls at 1-10× the size of biological targets to be studied and interrogated, but sometimes can be up to 20× the size. Generally, this is between 1-200 um in a cross-section of one plane (e.g., XY, XZ, YZ, etc.), but it could cover devices with features of less than 200 um in a cross-section of one plane (e.g., XY, XZ, YZ, etc.), of less than 300 um in a cross-section of one plane (e.g., XY, XZ, YZ, etc.), of less than 400 um in a cross-section of one plane (e.g., XY, XZ, YZ, etc.), and of less than 1000 um in a cross-section of one plane (e.g., XY, XZ, YZ, etc.) for chambers. These small features on the device are for carrying, exchanging, extracting, moving, trapping, counting, analyzing, lysing (or breaking apart), mixing one or more fluids, cells, chemicals, biological entities, and other payloads for the purpose of gaining useful insight and/or data for decision making on patients, or a general process understanding of the interactions of those payloads and the other tests designed on the devices. These interactions can be, by way of non-limiting example, for tumor mimics, tissues, vasculature, proteomics, genomics, phenotyping, DNA sequencing, and re-grafting, bioreactor growth studies, Ph, oxygen content/saturation, conductivity, salinity, cell viability, reactivity to electronic fields, signals, etc.

In addition, microdevices or microfluidics may rely on an auxiliary portion (or portions) of features of a device with channel(s) and/or features(s), such as open channels and connections; by way of example, there is a term called Chip-to-World connections signifying the connection from the macro-to-micro world of the chip within the 200-1000 um size range. Other terms and nomenclature such as Lab-on-a-Chip (LOC or LOAC), point-of-care (POC), microdevices, MEMS, Optical waveguides, sensors, implants, vaccine delivery systems and related terms, can be used to describe the technology that relates to the invention described herein, so they would be understood by one of ordinary skill in the art to relate to the current invention and therefore the current invention could be used in such technological fields and cover such fields.

The current invention can include the capabilities for clear, biocompatible resins with single micron level resolutions of infinite size (XYZ) and can eliminate the need for any type of mold for prototyping or production. This affects the infrastructure of clean rooms, molds, personnel, and the like eliminating, by way of example in aspects, about 95% of the wait time for initial testing, such as testing of ideas. It can be fast enough to be used for mass fabrication. According to the present invention, agile and comprehensive device testing can be completed in shorter periods of time and for lower costs, and readily integrated into systems for Manufacturing as a Service (MaaS) and Industrial Internet of Things (IIoT).

The current invention can form solids by exposing a liquid resin to particular bands of light (spectrum) selected from the original light source (bandwidth) in a layer-by-layer format; with each layer being attached to the previous via the influx of uncured resin and subsequent exposure to UV light. To form the preferred object the layers function to create a realistic, and tolerance correct 3D device, and an intrinsic need exists to have areas and volumes of uncured resin interspersed with those which have already been cured. This can require that the depth of penetration for curing or polymerization is controlled and intentional, and with microdevices, this can be preferred. Usually, the consequence of this process is a singular depth of cure and hence “layer height” of slicing-every layer of an object is exposed to the same dose of UV light, in aspects.

The current invention can use multiple wavelengths and segments of the UV/Visible spectrum both between and within the layers to develop a multi-voxel polymerization method, controlling the depth (Z) and width (XY) of penetration independently and in real time or near real time between, through and within layers. It can also tune a particular LED array, for example 385 nm or 365 nm to be more accurate. For example many LED arrays that claim to be 365, 385 or other, display extra light beyond an accepted 10 nm spectrum, this is known because all of those wavelengths should be invisible to the human eye, but personnel ca tell the bulb is on without the filter. However, with the filter in place, the bulb spectrum is invisible to the human eye. This extra light can cause polymerization beyond what is expected.

The current invention includes a method for using a wide-spectrum light source with a spectrum that extends beyond the boundaries of the UV absorption spectrum of the photo blocker; this includes an array of multiple wavelength LEDs spanning the UV spectrum of 265-500 nm, by way of example. It also includes the idea of using several different LED arrays that can be tuned, if necessary via light filters, to employ different curing rates and times for different resins with variable attenuation for light and light blocking depending on the photoinitiaors/photo blockers.

The current invention can use different wavelengths to alter the cure depth and/or cure rate by employing filters or different LED/narrow wave-length light sources. This novel aspect of the invention can be utilized to through-cure the device while on the machine elevator while retaining tolerances, which is both novel and non-obvious from previous art, and useful as compared to standard SLA/DLP, which requires curing in a separate chamber after removal from the 3D printer. Instead of using a single wavelength and extending exposure time per layer, the current invention, in embodiments, can adjust controllable cure depth penetration up to 100× distance via the selection of various segments within the active spectrum of the resin-which may be within the UV (including Deep UV and Extreme UV) and the visible spectrum, dependent on the construction of the resin and selection of resin components. The duration and intensity of those wavelength selections can at the same time alter the required exposure time during a single layer or any temporal period for 100× increase in speed of print, measured in z or volumetric rate). This means a layer or portions of a device in the Z-direction may be cured at any time during the print, including different cure heights within the same layer. By using a light source with a wide spectrum and filters, different portions of the additive properties from competing material totals may be exposed to the device, allowing different penetration depths at different times of the device construction-allowing selective crosslinking or stiffening of internal device segments or complete device curing for enhanced burst pressure and resilience, while preserving the uncured resin within the channels.

This enhances the application of additive manufacturing using photo polymerization to solidify an object, adding new functionality and allowing additional control and fidelity over the percentage of crosslinking density during the print process. This novel aspect of the method can allow several advantages over other 3DP systems; the speed of fabrication, reduction of post-processing, post-processing in-situ, controlled internal cross-linking for structure and strength, and/or fine-tuning via new dosing algorithms. Further, it can offer the ability to enhance the creation of internal structures important to the requirements and functionality of microfluidic devices and diagnostic tools based on these methods by allowing increased degrees of freedom in design.

In embodiments, the current invention can be a method of enhanced speed, fabrication, and development of microdevices such as Lab-On-A-Chip and microfluidics, wherein, in aspects, the features and layers comprise combinations of extremely small solids and voids. The layers may be deliberately different heights depending on the situational position and function within the device volume—e.g., channel walls or surfaces vs. bulk material (e.g., material 2× pixels from the channel wall). In addition, the invention can expand the ability to cure the boundary segments at transitions between a bulk solid to bulk void. These transition areas are generally known to be the edges of the solid-void areas. In cases, transition areas require different doses contained within a single exposure. The method explained herein as part of the current invention can increase and selectively tune the cross-linking in different areas immediately next to one-another as well as the light penetration to adjacent pixel areas which may or may not be active on the digital micromirror device (DMD). This can be used to enhance printing resolution below a standard pixel size/pitch. “Tune” can in aspects mean increasing or decreasing the polymerization rate, speed, and/or area, along with other parameters, via controlling the photon dose and spread through wavelength and lumens. “Tune” can also mean retaining the intended size, shape, and form for the resulting physical 3D printed microdevice—and making it match the drawing, for example. This can result in a new set of evaluation parameters for resin and its constituents as well as the controlling factors for polymerization.

Another aspect of the current invention pertains to the elevator platform, “Chip-Clip™” and the attachment method for glass slides to allow quick loading and unloading of a device to the machine. Within this same machine aspect, the current invention pertains to how to use a small camera to capture information on the print on a per-layer basis-this can allow for the ability to integrate quality control and capture data from each print. In aspects of the invention, the inventive machine/apparatus can use a pivot on the chip clip to allow faster lift and reset time for the resin to refresh between layers. This lift-reset time can be important to the speed of a print and typically is a constraint within the 3D printing community. In furtherance, the current invention described herein shows how to use a small gantry to reposition the elevator and build a platform allowing a larger object to be printed than can be done with a single projector or DMD. The invention is also a method to de-couple the projector from the pixel array-allowing pixels to be placed anywhere within the XY plane (for example, ½, ¼, ⅛ and 1/16 of a pixel spacing, but it is limited, in aspects, only to the stepper motor and leadscrew pitch). In addition, the invention described herein shows how a motor could be used to alter the cartesian-based printer into a rotary-based method, eliminating pixel stepping in XY.

The current invention can automate the pixel pitch between and during layers for enhanced resolution and speed of printing devices, which is discussed in further detail herein.

Thus, in aspects, the current invention is a 3D-printing system comprising an off-the-shelf home-based (e.g., entertainment) projector, specifically designed focusing apparatus, custom resin formulation, and low-cost parts for the creation of microdevices. The use of an off-the-shelf projector can allow for future-proofing by the intrinsic and automated evolution of new and improved DLP projector systems each year. As an example, this system could currently be a 4K micro-printing system, but future 8K projectors (and future iterations) could also be used for the light-source. The 3D printer, in aspects, has a projected image pixel pitch which can be altered between 1 and 100 ums at any time before, during, or after the print. It can use a standard mercury bulb which has a spectrum from 325 nm through the visible light and into the infrared (+1000 nm), by way of example. It can employ a series of filters that select or tune the light/bandwidth/wavelength spectrum of the original light source coincident with the plane of polymerization. This can allow for the use of more resins and photo-initiators than possible with single channel (using one array of one LED type, e.g., 365, 385, or 405 nm). The invention can, in aspects, use a standard resin and by filter or multi-wavelength LEDs to truncate the incident light spectrum, it can tune the depth of penetration and cure rates. Through empirical evidence, it is shown that this depth and rate of cure can be dependent on the two curves of photo-initiator and photo blocker along with the light spectrum allowed, by way of example.

This can be demonstrated by fabricating several devices with channels and features at and below 100 um in a few minutes or less. According to the current inventive method, materials, and machine, an unexpectedly superior point of 3D printing has arrived according to current invention as compared to other mass fabrication methods such as high-cost Si wafer etching and low throughput PDMS replicate molds and changing materials once at mass-fabrication levels required by micro-injection molding. These improvements allow for, among other things, a reduction of product development timelines and a lower need for additional experiments often created by the current manufacturing requirements of low-cost PDMS moving to high-cost and new materials at mass fabrication. Further, it allows for flexible and agile production lines, lower infrastructure costs, and eliminates the financial hurdle to treating diseases with lower prevalence. The production via 3DP according to the invention herein also illustrates the capacity to remotely fabricate new diagnostics which are currently unavailable due to these manufacturing constraints.

The features disclosed herein may be used singularly, in any combination, or combined based on the requirements and specifications of a given application or design.

### BRIEF DESCRIPTION OF THE DRAWINGS

The accompanying drawings illustrate certain aspects of embodiments of the present invention and should not be used to limit the invention. Together with the written description the drawings explain certain principles of the invention.

FIG. 1A Depiction of types of additive manufacturing vs. physical size scale.

FIG. 1B Table on microfluidic requirements.

FIG. 2A Schematic of the 3D printing invention according to embodiments described herein.

FIG. 2B-C Photographs of inventive/improved optic arrangement according to embodiments of the invention as described herein.

FIG. 3 Schematic of automated pixel focus, according to embodiments of the current invention.

FIG. 4 Image of shutter with filter locations, according to embodiments of the current invention.

FIG. 5A-C Filter ranges used for 3D printing improvements, according to embodiments of the current invention.

FIG. 5 D Originating light source spectrum from projector bulb, according to embodiments of the current invention.

FIG. 5 E-G Filter ranges are outlined in a box to depict segments of the projector bulb spectrum that are allowed to be displayed on the polymerization zone, according to embodiments of the current invention.

FIG. 6A-D Pixelated surface roughness schematics and table, according to embodiments of the current invention.

FIG. 7A Chip-Clip™ or Build Plate Attachment, according to embodiments of the current invention.

FIG. 7B Chip-Clip™ or Build Plate Attachment with camera, according to embodiments of the current invention.

FIG. 8 Chip-Clip™ or Build Plate Gantry, according to embodiments of the current invention.

FIG. 9A-F Representation of process to use build plate gantry, according to embodiments of the current invention.

FIG. 10 Different size pixels on a circle, illustrating better resolution, according to embodiments of the current invention.

FIG. 11A-D Scenarios for pixel size, DMD array, ultimate build size and resolution, according to embodiments of the current invention.

FIG. 12 XY gantry depiction for projector carrier, according to embodiments of the current invention.

FIG. 13A-F Depiction of pixels for resolution vs. SLA-mode for DLP, according to embodiments of the current invention.

FIG. 14A-F Microdevice scenarios of circuitous routes and branched or bifurcated channels, according to embodiments of the current invention.

FIG. 15A-C Depictions of rotation pixels for aligned resolution to printed object, according to embodiments of the current invention.

FIG. 16A-C Depictions of resulting resolution from half, quarter, and motion of single pixel aspects, according to embodiments of the current invention.

FIG. 17 Multi-layer or Multi Voxel schematic, according to embodiments of the current invention.

FIG. 18 Decision making matrix, according to embodiments of the current invention.

FIG. 19 Rotary stage on XY platform with Z projector motion, according to embodiments of the current invention.

FIG. 20 Resulting interaction graphed between photoinitiator, photoblocker and filter, according to embodiments of the current invention.

FIG. 21 Cure depth vs. speed for multiple resins and filters, according to embodiments of the current invention.

FIG. 22 Microscope imaging of micro channels voids and circular cross channels, according to embodiments of the current invention.

FIG. 23 Depictions of dimming or greyscale, according to embodiments of the current invention.

FIG. 24 Graph showing the effect of bandgap selection via optical filters and greyscale dimming on the cure rate and depth for single initiator photoresin, according to embodiments of the current invention.

FIG. 25A-G Depictions showing resin thickness vs. exposure time and

dimming, according to embodiments of the current invention.

FIG. 26 Pictorial representation of micro-needle arrays via a single exposure, according to embodiments of the present invention.

FIG. 27 Depiction of calibration “lollipop” STL model, according to embodiments of the current invention.

FIG. 28 Graph of absorption curves of individual resin parts, according to embodiments of the current invention.

### DETAILED DESCRIPTION OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

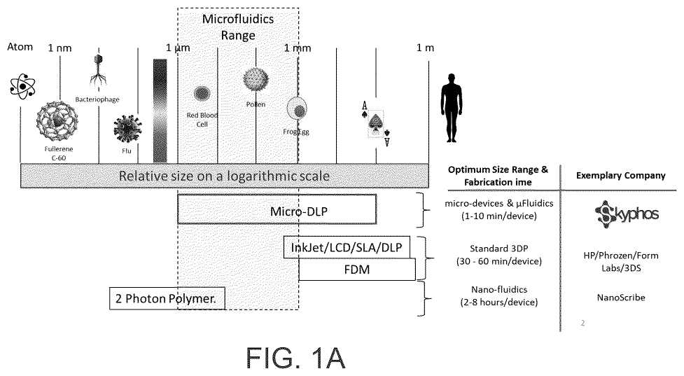

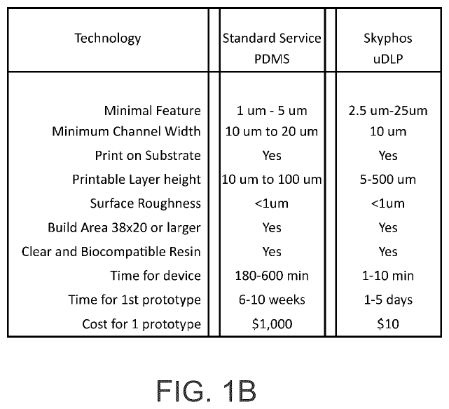

FIG. 1A illustrates the gap existing manufacturing gap—the inability of 3D printers to create objects in the macro word, the size of a credit card, along with features smaller than a human hair. Typically, printers can do one or the other but not both. FDM printers which use thermoplastics and a small nozzle, can print macro-objects but not micro features. The same is true for most vat style printers. These printers specialize in creating objects that can be held in the hand and with features visible to the naked eye, such as for dentistry and jewelry printers.

Printers also exist that specialize in the nano and microscopic area are those like 2PP. These types of printers can achieve features in hundreds of nanometers up to a few millimeters in size. The prints use highly specialized resins and take several hours to build. The ultimate size is limited and below the threshold for standard microfluidic cartridges that range from 2-20 cm.

Thus, the need for a microfluidic device resides in this gap area and cannot be serviced by standard printers.

The current invention, in aspects, includes a set of optics, mechanics, resins, and algorithms that can enable large format devices (macroscopic) and can print microscopic features in a clear resin. In the FIG. 1A area labeled “Skyphos,” it shows an example of a range that can be achieved, in aspects, according to the present invention. FIG. 1B shows a comparison table between the understood requirements for mold-based PDMS tolerances vs. those achievable from Skyphos according to embodiments of the invention as described here. It is noteworthy to understand that 3D printing in this case can surpass the current state of the art in speed, tolerance, build platform size, and in costs. These achievements are not trivial and required hundreds of rounds of tuning experiments to determine the interactions and ranges for polymer chemistry, optics, resulting surface chemistry, and computer algorithms.

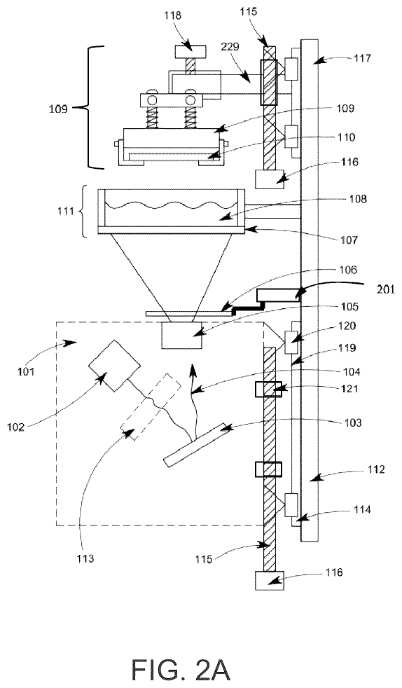

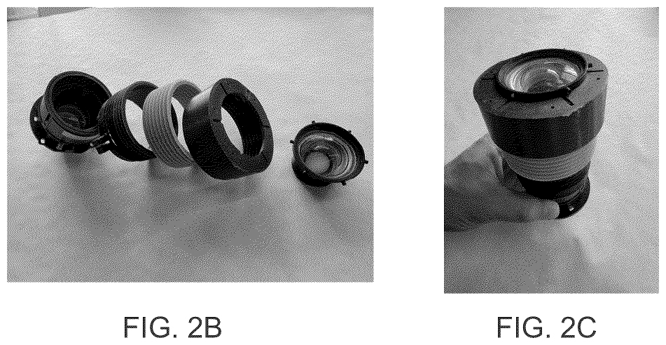

FIG. 2A shows a schematic of a vat-style bottom-up 3D printer according to an aspect of the current invention. Images can be displayed through the Projector, aka Light Engine (101). The light engine or projector can comprise a light or radiation source (102) that can create a wide light spectrum, such as in the case of a standard projector bulb, and in this embodiment preferably a metal halide bulb. However, a set of highly specific light sources such as lasers, or an individual/set of LEDs, or array of LEDs with multiple wavelengths with an appropriate wavelength(s) or more preferably an array of multiple wavelengths, may be used. It is envisioned that there will be cases where an LED with a called out spectrum produces light outside of the published spectrum, or produces stray light. While it may be eclipsed by a preferred spectrum of by 10x or more, for example, these stray photons can cause issues in the manner of over cure in XY or Z, or a combination, due to their different energies.

By way of an example, an illuminated 365 nm LED should be invisible to the human eye, but some visible light is produced because a human can detect the light is on. In cases like this where an LED has extra wavelengths beyond the spectrum cited, and this light is within the photoinitiator's range of activation, it may be necessary to “clean up” the extra spectrum by using an appropriate light filter, such as colored glass or other optical filters, and such as those offered by Thor™ or Edmund Scientific™. These filters can, in aspects, reduce the original spectrum of light-despite only a small amount falling outside the spectrum, this allows only the band gap of light to pass that the 3D printer technician needs to directly interact with in regards to the photoinitiators. It is envisioned that a filter may be necessary to split the allowable light from the original LED to a portion of its bandgap to control cure depth and cure rate more suitably, for example reducing a 365 nm bulb, which has a general spectrum from 360-370 nm to only 365-370, or a 385 nm LED to 385-390 rather than its standard 10 nm bandgap of 380-390 nm. A Digital Micro Mirror Device (DMD) (103) using micromirrors, can direct the light (104) to the pixel areas focused on the vat (111). The lens apparatus (105) can focus the pixels to a preferred size (e.g., 0.1 to 100 um) on said a window/working layer. After it exits the final lens, a filter or arrangement of filters on a shutter (106) controlled by a servo (201) can attenuate the full spectrum of the light source (e.g., LED array/full-spectrum bulb) to the preferred band gap for current required layer height, as well as control over cure distance and speed of polymerization. The filter or filter pack (e.g., multiple filters) may also be mounted internally to the projector between the light source and DMD in the dashed area (113), in place of, or near the color wheel. In aspects, a stationary or mobile filter can be placed anywhere along the image path between the origin of the light source and the final plane of polymerization or working area.

The resulting image of a preferred size and brightness can coincide with the vat window (107), which can be attached to the vat and subsequently attached to the frame of the 3DP (117). The light can penetrate the window on the vat which can hold photopolymerizable resin (108) and the build platform (aka. Chip-Clip™) (109). It can display an image to be polymerized; it may be all or any portion of the current layer/active layer. If it is an initial layer, the Chip-Clip™ can hold the substrate which the object/device can be printed on, such as a glass slide (110). It can be inserted at the beginning of the print and brought to a preferred location at the “working layer,” such as an area located between the top of the vat window and the bottom of the slide, or a last printed layer, in aspects, within 1 um to 2-5 mm. This is a larger range than standard 3D printers which have working ranges of 20 um-100 um. The working layer can be the current layer being printed. The working layer may, in aspects, also be synonymous with the slice or slicing height, or layer height. This height for VPP based machines can be a singular height from start to finish of the print, and herein it is taught how to vary this height using different filters, light sources and exposure times, allowing it to be dynamic during the print. With these teachings discussed herein according to the current invention, a singular resin construction with the knowledge of its constituents can be made to print 1000× or more faster and thicker than previous technologies. A variance of 1 um and 2000 um (a 2000× range) may be accomplished, in aspects, depending on the filter, exposure time, and resin construction selected, by way of example and as explained herein. In previous art, generally the exposure time was extended per layer, allowing the working height to fall between 20 and 100 um (a 5× range) for a few seconds difference in exposure. Herein, the invention, in aspects, includes an indirect and non-obvious expansion of this technique as it needs to be mapped and empirically understood to place into practice.

According to the current invention, the penetration distances of two different bandgaps of light (for example, 10 nm) penetrate differently and can polymerize to different extents in time and cross-linking. This can occur while the bandgaps are different but yet still under the overlaps of the combined PI and PB curve. Further, combing these bandgaps results in a third functional curve for cure distance and cure rate. The working layer thickness on a per-layer selection (dynamic layer) can be a different thickness. Additionally, each layer may have more than one exposure time using a different filter and altering the addressable cure depth or working layer distance which is called “dynamic slicing” or “dynamic slice height,” or “dynamic curing distances.” After the segment of printing is complete (e.g., sometimes referred to as a “layer”), the platform or Chip-Clip™ (109) can be raised to a sufficient height via the combination of the motor, linear slides and lead screw activation (229, 115, 120, 114) to allow the new resin to backfill in the area where the previous layer was solidified. The elevator can be brought back to the preferred position, depending on the working layer height. The cycle continues until the end of the part.

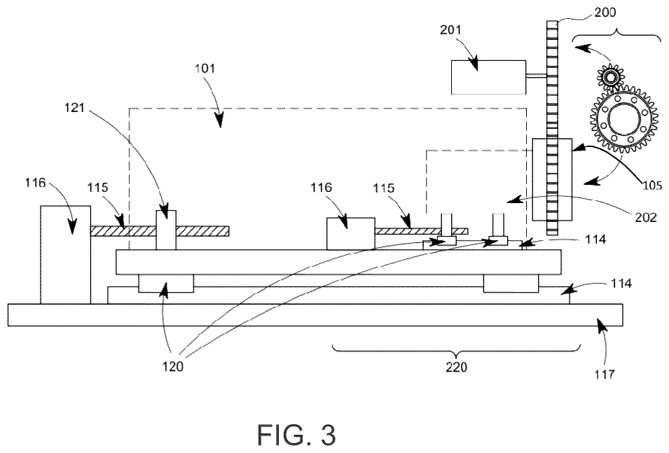

The current invention can allow for the ability to move and reposition the projector (101) in Z to allow for automated positioning with a gantry and associated parts. Using the exemplary product in FIG. 2 and FIG. 3, for example, the invention can include a set of linear rails (114), stepper motor (116) or servo (201), and linear screw (115). The focus of the projector can be adjusted via two independent motors (116) which control the fine focus via a gear set (201) and the zoom (220) of the lens package (see, e.g., FIG. 2), or via a linear guide (114). In this way, the current invention can allow for movement of the projector lens distance and focusing in real time on the working layer. This overall range of projector travel and position is generally from a location where the final lens is in direct physical contact to the underside of the vat window, to a distance of 500 mm or more below that level.

The projector positioning for each pixel aspect can be stored in a library lookup table of the 3D printer. If a pixel position is called for which is not available (e.g., in between two hard-coded pixels) a linear calculation can be performed for positioning via an algorithm, by way of example, in JavaScript, C++, Python, or any of the other multitudes of programming language. The code does not necessarily need to be directly readable in g-code and may only output the final numbers called for by the program which will then install the output into the final code, as is done in many computer languages. To perform the calculation, the algorithm can look for the preceding pixel and the next largest pixel in the library. Using these as the range it can then determine what percentage of this range is required and add this number to the preceding pixel location-thus providing the new coordinate to each motor. The master program can use the actual library number or the calculated step and a call movement in g-code can be sent to the three motors controlling projector positioning on the linear rails, focus, and zoom. General functions which describe the position for each motor given a set of parameters can be developed which then also eliminate the need for a direct library. This general function may be of a curve, logarithmic, quadratic, decaying exponential or linear, or determined by experimental/empirical data via a linear regression equation over a set of points for each motor along the total range of the pixel sizes or a combination of any above. Further it can use the curve to extend beyond known data and use a forecasting method.

### Shutter and Filter Set:

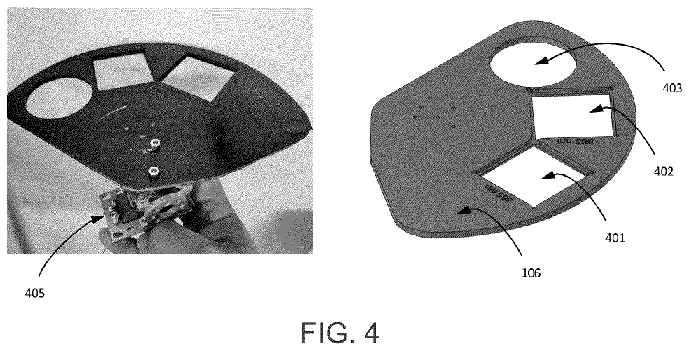

DLP printers and LCD-style printers in FIG. 4 can utilize a shutter (105), which when activated, eliminates some or all light from the bulb or LED array by interrupting the beam path. The positions for this example of the shutter are (401, 402, 403), where 401 and 402 have locations for a square filter to be installed, and 403 is an open position to let the entire spectrum from the light source pass, and, in aspects, the area next to 401 can be used to completely shut off light from the light source. The control and selection of each of these positions from the shutter can be initiated via a software signal to a servo motor (405), by way of example. According to the current invention, it was determined that integrating filters between the originating light source and the vat window is, in aspects, a preferred step to attenuate and tune the light bandwidth. It was determined in most cases, but not all, that a single filter allowing a range of 10-100 nm was sufficient, but filters with wider band-pass regions and/or dual filters that have spectral overlaps are envisioned.

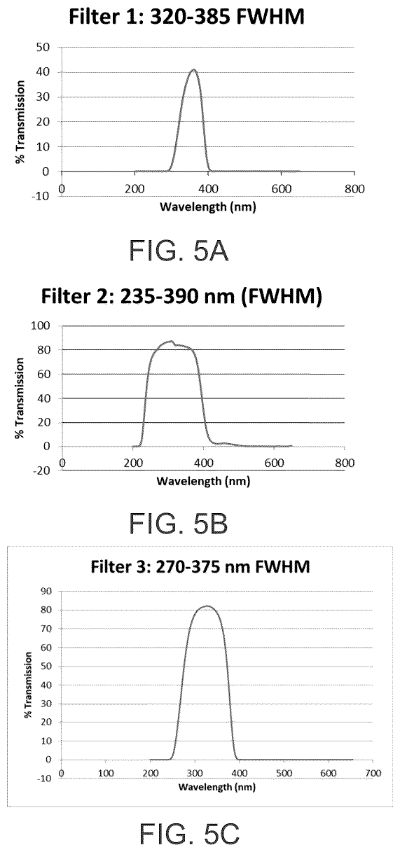

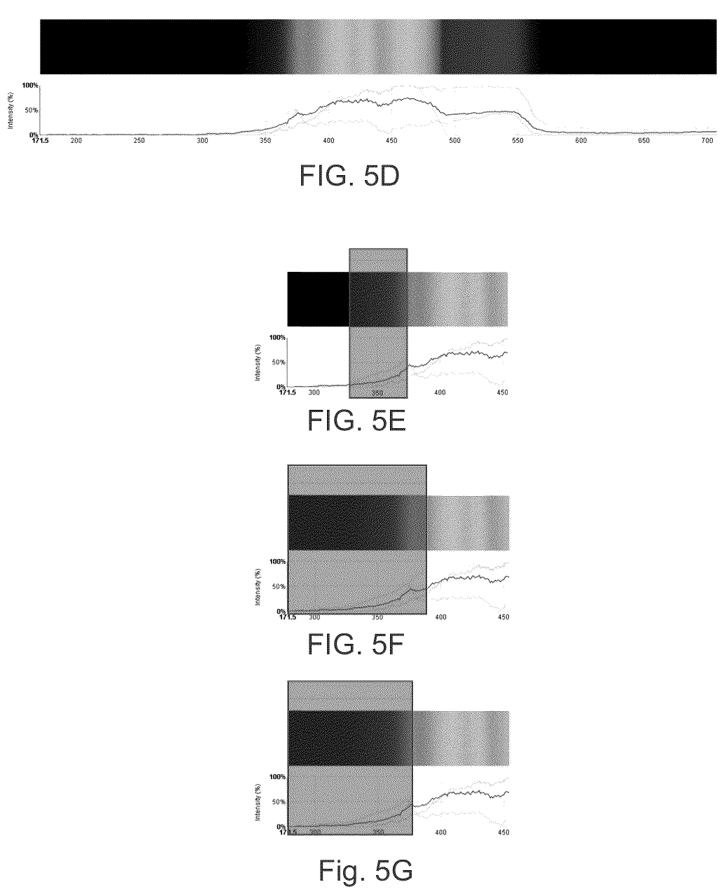

Shutters that completely interrupt the light are important to use for control of light from the projector, as projectors even while displaying a “black” or “blank” screen during peel moves to refresh the resin allow stray light which can polymerize resin, however they cannot tune the original source to remove stray light or the extra spectrum beyond that what is intended or desired from the vantage of printing an accurate model to the drawing. Therefore, the current invention expands the design beyond a binary on/off shutter (403, 105) and introduces a series of optical filters (401, 402) to the shutter to both tune the light source (e.g., bulb, LED array, set of lasers, etc.) after it exits the final projector optic and allows adjustability in the spectrum during the print. The selection of different filters and band gap of light shown in FIG. 5 which is directed to the working layer affects the speed and cure depth of the resin. Filter selection can be done by operator input or computer controls, such as a library look up table or a resin profile. A resin profile can be similar to a recipe and contain some of the controls to and instructions for the printer to cure a layer properly. FIG. 4 is a picture of an embodiment of the inventive shutter (106) described herein with two separate filter locations, a 365 nm filter (401) and a 385 nm filter (402), between the light source (102) and DMD (103) and after the final lens adjustment (105).

This inventive shutter in FIG. 4 still can be used for the purpose of blocking all light but adds a selection of band gaps that were identified from experimentation and iterative tuning (empirical discovery) as to proper formulation to develop a resin with reactivity but controllable and tunable penetration depth of and rate of cure at each layer, or intra-layer. Between and within each layer, a shutter (106) can be activated via servo (201) or appropriate motion apparatus and attached to the printer. It can be rotated to distinct positions (401, 402, 403, 404). These positions coincide with a completely open position (403)—(no filter), and several mounted light filters which may be interchanged by the user (401, 402), and fully closed (404). These different filters, by way of non-limiting examples, vary in wavelength the ranges that are allowed to pass, and are considered filtered or colored glass. They are tuned to the resin to allow different amounts and types of light to be displayed on the vat window (some of those used in testing were from Thorlabs™, Inc., such as UV5, UV11, UV9S, and UVS).

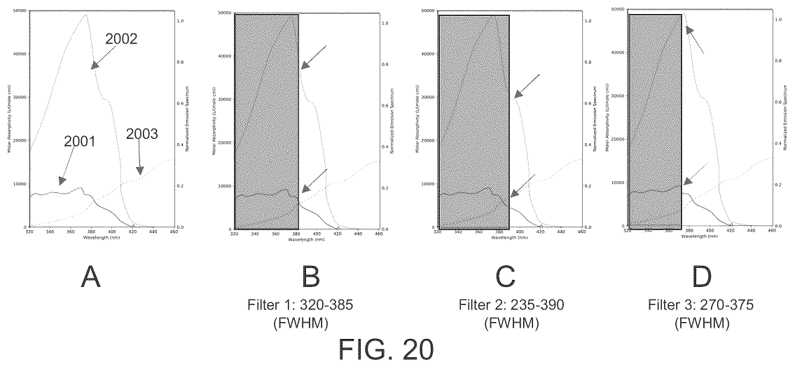

In FIG. 5A-C, the bandpass ranges and percentages passed are shown. FIG. 5D shows the spectrum of an unfiltered projector bulb. FIG. 5E-F shows a combination of which areas of the original light source are allowed to impact the vat. FIG. 20A-D shows the light source spectrum (2003), absorption of the photoblocker BBOT (2002) and Photoinitiator TPO (2001), along with the band pass regions of the Thorlabs™ filters (different boxed regions from B, C, D). It is noted in FIG. 20B-D (using arrows) that the cut off wavelength for each filter changes the distance and integrated effects of the light over the band-pass width between the two ingredients which will be dominant, the PI or the PB. The filters incorporated to a projector may number one or more, and many more positions of the filter and other shutter designs are possible, by way of non-limiting example, rotating individual filters as in, for example, FIG. 4, a single track of filters in a linear fashion, etc. These filters may also be combined by using two or more in combination to offer a more customized filtration of the light-source than would be available through a single type of filter or colored glass, for example further narrowing the allowed band-gap.

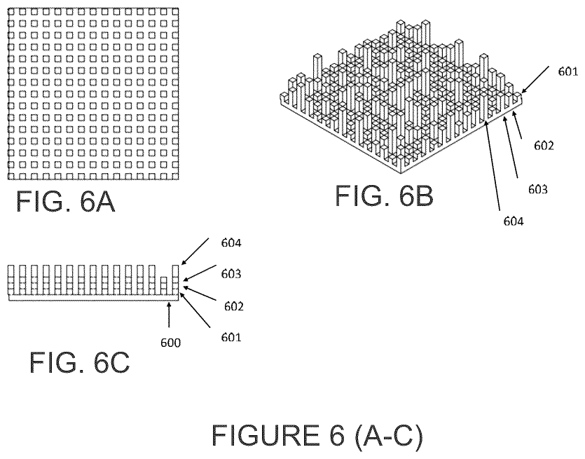

While these are preferred band gaps, in embodiments, via filter for the projector and current resin, which are used to attenuate and reduce the original light spectrum from the irradiation source to a preferred spectrum (also referred to herein in this disclosure as bandgap or bandwidth), other solutions exist according to the current invention, such as using a bank or multiple channel LEDs at appropriate wavelengths with or without filters. This is especially true since LEDs have controlled ranges within the 250-500 nm range, generally with a bandgap of 10-20 nm, meaning these can be found with the FWHM centered around primary wavelengths within the 320-410 nm region. The 320-410 nm region enjoys some of the most useful photoinitiators used in resin construction today. The LED bandwidths are generally controlled, therefore they would be a preferred choice for multiple bandgap or multiple wavelength light engines and also be able to take advantage of other aspects of the invention described herein. Different resins with varying photo initiators and photo blockers will require different filter or wavelength ranges. Further, by using filters/multiple wavelengths and addressing different individual pixels at different times or different exposure patterns for a group of pixels within a given layer, for example 365 nm, 370 nm, 375 nm, 380 nm, 385 nm, 390 nm, 395 nm, and 405 nm, the effect can generate a custom surface roughness as different pixels are cured to different depths and different penetrations, even if these areas are interspersed with one another, this is important for microfluidics creating passive mixers. (See, e.g., FIG. 6A-C.)

### Chip-Clip™, Elevator, and Printing Substrate:

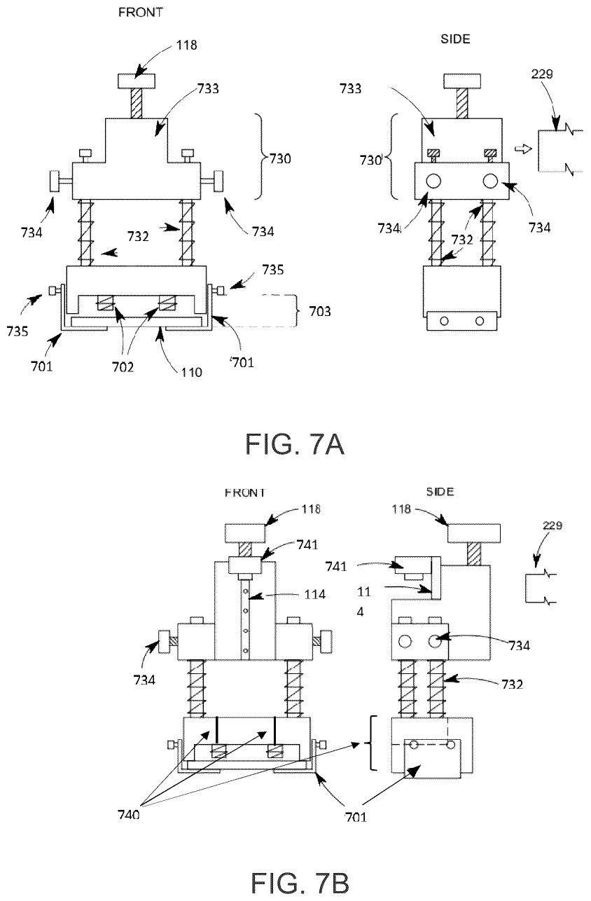

FIG. 2A shows aspects of the Chip-Clip™ (109) along with a glass slide substrate (110) installed. FIGS. 7A and 7B show aspects of the invention in additional detail. The use and speed of a 3D printer for high-throughput microdevice fabrication have been improved by designing and implementing a Chip-Clip™ which can be integrated to the standard elevator on a 3D printer (109). As most microfluidic devices are mounted to glass slides as shown in FIG. 2A (110), this Chip-Clip™ allows for the installation and precise location of the glass slide (110) for accurate printing. Further, the slide can be removed for an intermediate process, perhaps for a sensor installation, or addition of electrodes, or secondary material, or membrane, then the part can be re-installed to the Chip-Clip for completion of the part while keeping all locations the same.

To install, the elevator with a glass slide is lifted to the preferred height above the vat and liquid resin within. Next, a substrate, a glass slide (110) in this embodiment-but the substrate could be of metal, Silicon, ceramic, plastic, other organic material or substrate coated with organic material, silane, adhesive, or other special material-is inserted between the clips (701). The clips can hold it without the use of other attachment mechanisms other than friction and spring force, in aspects. The glass slide can be located within the clip via springs clamps (702) or by way of non-limiting examples, other flexible guides, ways, printed springs, etc. By way of example, the clips can be bent at approximately 90-95 degrees and mounted with screws (735) or another fastener method to cause slight pressure on one side of the slide to push it to a hard and indexed position against the other side. A relief can be cut out above the slide to allow operator hand installation/toolless installation. In the configuration, a second spring (702) can be in place directly above the slide and put pressure to hold it down in the Z direction onto the bent portion of the clips.

The clip: A mounting block (733) shown in FIG. 7A is attached to the elevator of the 3D printer (229) via, in aspects, a hand tightened screw via a knob (118) or other fastening mechanism. The quick release block (733) can hold, in aspects, four vertical rods on springs (732). The rods can be free moving within the mounting plate guide holes until a second fastening screw or set screw (734) is tightened against them.

In this way, the clip can be lowered to the “zero” or “home” position and aligned parallel, or in plane, to/with the build window with the set-screws (734) loose. The spring activated rods (732) keep the plate level and flat against the build window (107); the set screws are then tightened, and the clip is level, and in plane with the build window, and remains so during printing use. This functionality, in a preferred embodiment, is tool-less by design, and can allow for switching out a Chip-Clip™ and leveling a new one in less than 1 minute (by way of example only) from an operator using one hand which is important for fast and agile manufacturing.

The “zero” position is the initial layer position for the first bonding layer. This initial layer is one “layer height” above the top of the vat window. A layer height can be determined by the user in the initial slicing of an STL object. In embodiments, the standoff distance when using a clip or mount will be, at minimum, the thickness of the clips (701) which hold the glass slide in place. It is also possible to use suction, adhesive, magnets, etc.

According to testing, it was found that 0.25-0.5 mm aluminum or 0.15-0.35 mm Stainless steel can be used and is a preferred embodiment, but other materials may be used for the clips with varying thicknesses up to the ultimate cure thickness allowed by the wavelength used for polymerization and the resin reactivity. According to experimentation, the maximal resin height useable was found to be 1 mm before losing excessive tolerances for XY plane (e.g., vias and holes) beyond 100 um, and if no tolerances are needed for features like vias, holes, pillars, designs, or masking marks, 2.5 mm or more can be the maximum. Therefore, in aspects, the preferred range of material thickness for the clip in practice can be between 0.15 mm and 2.5 mm.

### Camera on Chip-Clip™

According to existing art, 3DP programs use a simple call for the camera between layers to take an image so that a set of stills for the print may be placed together in a timelapse video, however, these images and methods currently only exist for the side or sometimes an orthogonal view of the working zone. One of the most active areas of interest for liquid-based 3DP is understanding and confirming the correct dosing of a layer as the number of photons, or photons/time affect the strength and percent conversion of the monomer to polymer as well as cross-linking coefficient. This conversion rate has a large effect on downstream biocompatibility and overall strength/flexibility/part integrity. While it is interesting to watch a slow-motion video of a part as it is being printed, it does not add to QA/QC of parts. However, the data on the dosage and per layer printed are important for SLA printers that use light to cure each layer. According to the invention herein, a camera can be positioned directly above the working area, and using a wavelength not absorbable to the resin, determine if pixels and dosing are correct for the polymer. It is an offline test that can be run before, during and after a 3D print to ensure that the print meets specifications for the client or user. Thus, according to the invention herein, this aspect teaches how to use light outside of the absorbing spectrum of the current resin.

Until now, Applicant believes that it was impossible to capture any of this information in real-time from a position directly above the area of polymerization. The previous methods for some information use a dosage calibration station located at the side of the 3D printer and off-line, or use an HDMI split cable. Neither of these methods captured the true data in a complete format. Thus, a need for an improvement exists, which is addressed according to the current invention.

FIG. 7B shows the Chip-Clip™ with a cutaway window (740) on the top. In FIG. 7B, a schematic shows where a camera (741) can be mounted above the mounted glass slide (110) enabling images to be taken of the slide and build process at each layer. The current invention allows for the ability to record XY clips of a vat-based printer sequence of all layers. The camera can be remotely triggered to take an image at any point in the build. The camera can be mounted to a linear slide rail (114) to allow focus adjustment as the device height increases. In aspects, the camera can be of the typical low-cost camera modules for Raspberry Pi™, such as the Camera Board V2, as this camera module is 8 Megapixels and could then be matched 1:1 with the number of pixels on the 4K. In aspects, this is important for data collection, especially in the case of regulations that may require in-process qc control checks.

To enable a recording or image without distorting or damaging a print, a different bandwidth of light must be used than for the polymerization, otherwise it would either cause polymerization (and eliminate what would be a previously printed channel), be absorbed by the photo blocker and not transmitted to the camera, or a combination of both. In this case, the invention can use a 500 nm cut-on filter with the light source, which allows only 500 nm light and above from the light source to be transmitted beyond the filter (green, yellow, orange, or red and into the IR spectrum). In this example, 500 nm would suffice as it is in the visible spectrum and the resin constituents are non-absorbing in the range above 420-450 nm, but different photo-initiators would need different bands. In the case of LED-based printers, an array of LEDs would also suffice in place of a bulb with multiple filters, though filters might be used on individual LEDs to tune those exact light bandgaps, as some LED arrays have stray incidental light as many lasers do and need to be “cleaned up” via a precise filter. (See also, resin constituents below). Multiple LEDs and/or lasers and/or bulbs may be used simultaneously to tune the light curve to fit the specific resins and cure distance requirements.

A chosen layer may be used to log the information and it is also possible to use an extended exposure, moving the filter into position after the proper curing portion of exposure is complete. The image of the current layer can then be recorded as part of QA/QC. It can be logged as part of a run, taken at intervals during the print or print run. It can be used to determine if any pixels are “dead,” dim, or inactive during a particular layer and used to trace defects back. This is especially important in the case of gray-scale imaging to determine brightness as computer vision systems can determine more shading than the human eye can detect.

In this way, it is an added benefit of the invention by enabling the computer or 3DP to notify the process operator in real-time if a pixel is not “on” when it should be-or if the issue continued to occur or created a data log of individual pixel brightness over time. With this data made available, the process can be stopped, or a planned maintenance schedule could be enacted to change a bulb/projector. Thus, it can eliminate bad products from entering circulation. Data collection on proper processing for 3D printing is important, especially in a per-layer method. The camera setup according to the current invention offers nearly in-real-time collection. Further, in vat polymerization styles of printing without the current invention this data is nearly impossible to accrue due to each layer not being visible or able to be tracked. The addition of a camera with imaging per layer according to the current invention allows for closed-loop Quality Control (QC) with real time monitoring and analytics.

The current invention can utilize an adjustable camera mounted to an elevator, which can view directly over the printing area and can be focused on the working print area regardless of thickness of the object or position of the layer internal to the final print, as it can capture the XY plane at each layer.

### Gantry for Chip-Clip™

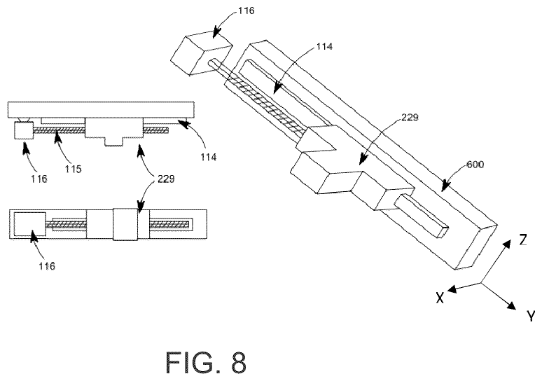

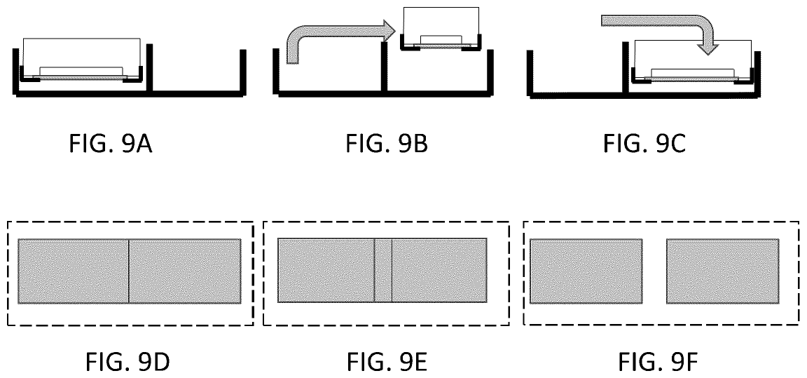

FIG. 8 shows a moveable gantry via micro stepping stage (229) and linear rail (114). This stage can allow for the motion and precise movement of the Chip-Clip™ over and within the elevator in the Y direction. The movement can allow for one exposure to be printed, and a second one after repositioning the stage can allow the doubling, or more of the printing area. This can be important in the case of a 4K projector using a 10-um pixel pitch where the final build area can be 38.4×21.6 mm. This size can be limiting as many uF devices require 75 mm in at least one axis. With the inventive gantry described herein, the Chip-Clip™ could be moved and double the axis length, for example. Further, it does not restrict the chip clip from one motion and distance. If the pixels were altered to 5 um pitch as described herein, the chip clip can move a preferred distance and still allow for the same overall build platform. In fact, the Chip-Clip™ with properly outfitted gantry motors and linear screw or nano XY stage could move any single distance, even a distance less than one-pixel width. FIG. 9A-F shows illustrations of several sequence variations of the gantry and pixel aspect customization. The FIG. 9A sequence shows first exposure for the layer is completed, then the chip-clip raises and moves in the Y direction during, followed by the stage dropping to position for the second exposure in the same layer. The motion in the Y direction can be equal to any amount of projector build area; from less than 1 pixel distance (by way of non-limiting examples <1 um, <5 um, or <10 um), to an equal amount of build area (in this example 38.4 mm), to more than the projector area. The multiple exposures per layer may take several forms; exposing a portion of a layer image and then moving to display the remaining parts, thus enabling a larger device than possible with one via “image stitching.” Or, using a similar technique, it is also possible to print a replicate (e.g., to make multiples of the same object in one print on one stage).

### Optics:

### Enhanced Optics and Focusing:

FIG. 2B-C shows the focus of the optic adjustment has been improved and now uses a series of threaded sleeves to adjust the focus. FIG. 3 shows the focus apparatus and the projector (101) mounted to the frame (117). The projector can be mounted with linear slides (114, 120, 119), allowing motion in the Z direction and a variety of different focal distances of the optical set (202). This in turn can allow for adjustment of pixel sizes in real-time by numerical control ranging from the Debye limit of light wavelength used. FIG. 3 shows the focusing apparatus (200) and a set of motors (201) allowing for control of the focus via a zoom motor apparatus (which, in aspects, comprises a stepper motor, linear rail and bearing, and a threaded rod) (116, 114, 120, 115, respectively), and a fine focus motor (200-201). By moving the projector to a preferred distance between the bottom of the vat in Z, and adjusting both zoom and fine focus, the system can be capable of adjusting pixel pitch at any time during a print, before, during, or after any layer. This can allow for fidelity and control over the pixel size and thus the resolution down to the Debye number (½ wavelength of a particular wavelength) and up. Generally, the most known common photo-initiators (PI) which are compatible with biological work, such as printing biocompatible material, exist between the 265 nm to 405 nm band gap; as such the minimal pixel size could be 0.1625 um or 0.0001625 mm. Increasing or lowering this minimal aspect is envisioned, as well is using Deep UV (DUV) and Extreme Deep UV (EUV).

Pixel Pitch Vs. Object Detail and Resolution:

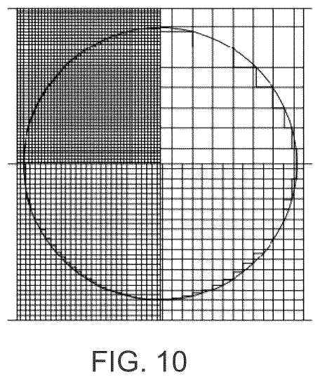

FIG. 10 shows a circle in four different quadrants with four different pixel pitches, illustrating there is a need for a high pixel count for precise resolution of objects and proper rendering. FIG. 10 is the result of large pixel pitches (047) combined with small pixel patches (048) illustrating how smaller pixels enhance the resolution or line tracing and fit of squares into a curve with fewer errors. The problem for ultra-high resolution 3DP is the reduction in printable area, juxtaposed with smaller pixel aspects, thus the need for a multi-mosaic array in some instances. To one skilled in the art, this figure illustrates the difficulty rendering small objects. The higher the number of pixels placed in a feature, the better the render or tolerance will be. The smallest circle could possibly be rendered with a 3×3 pixel grid, but a 5×5 grid is preferable, a 7×7 more preferred, and so on.

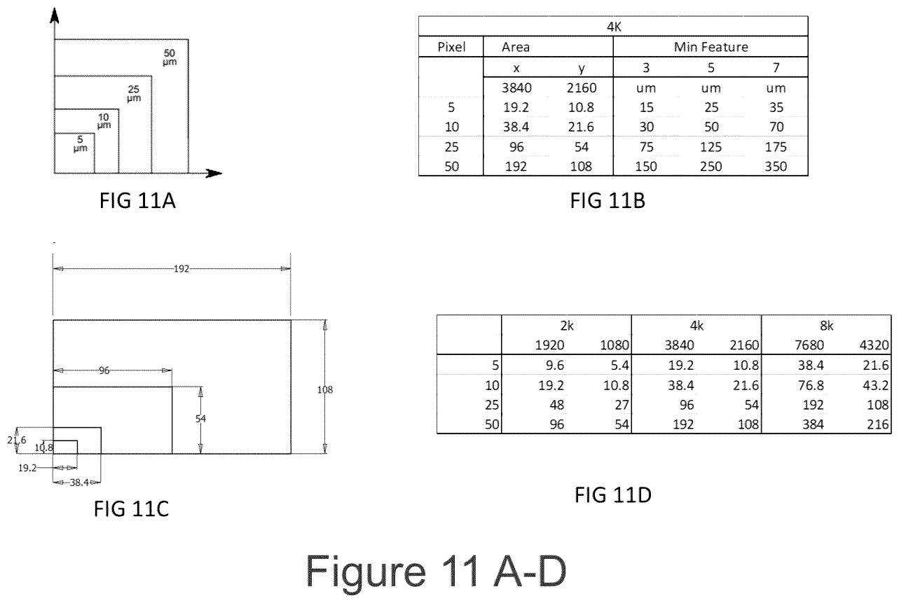

FIG. 11A-D is a schematic of various pixel pitches. FIG. 11A is illustrative of the size comparison (not necessarily to scale) of pixels between 5 um and 50 um. In FIG. 11B, a table lists the total sizes of the build plate resulting from these differences, illustrating the overall build area and the minimum feature size. In FIG. 11C, a schematic is representative of the differences in scale for total build area for the various pixel pitches shown (e.g., 5 um, 10 um, 25 um, and 50 um). In FIG. 11D, a table lists the total build area for one DMD exposure of various resolutions (e.g., 2 k, 4 k, and 8 k) vs. different pixel pitches. FIG. 11A-D illustrates, in examples, the problem with high pixel count per unit area-reducing pixel size to attain the needed resolution results in a substantial reduction in build size for a 2D object in XY, to the point of limiting use in the industry. This illustrates that multiple exposures can be necessary to complete complex layers or intralayer printing, and that the layers can be completed via a single pixel pitch with multiple adjacent and sometimes overlapping exposures, but that using different pitches reduces the total number of exposures and total number of moves a printer would need to accomplish per layer and per device, hence reducing the total time to print a given object.

### Multi-Pixel Pitch:

The resolution of a printer is generally limited to a single pixel aspect (XY) spacing to create or render any object. While there are certain techniques like dimming or grayscale to reduce or expand the cure of objects that are not a direct multiple of pixel spacing, these do not function very well in practice and can only be applied as a global setting per print-they cannot be tuned to individual cases per layer or even segments of a layer. The result is an object not a direct multiple of the given pixel aspect or smaller than a single pixel is at risk for proper tolerance, and for any features that border on this aspect. These factors should be considered as part of the design for additive manufacturing at the earliest stages of concepts and revisited at the time of any revision.

This is burdensome for engineers developing microfluidics and microdevices as the product typically transitions through several design revisions during their evolution. These design revisions are often the result of initial empirical testing combined with multi-physics programs like COMSOL to ANSYS—and the resulting changes may not always fit the pixel grid. The best-case result is pixel mapping, where features are designed to overlay directly with the pixel grid of the 3D printer. In the case of a channel width equal to a pixel, it should be mapped to the pixel grid. If a channel is between the pixel pitch or not a direct multiple, an operator/engineer then must either use a narrowing technique such as over curing where the layer is over-exposed and light begins to polymerize into a void, or use a gray-scale technique, or enlarge the channel to a multiple of the pixel aspect (e.g., 50 um×2 pixels=100 um). Unless pixels may be altered during the layer to enable smaller channels to be realized.

### Pixel Mapping and the De-Coupled Pixel Grid:

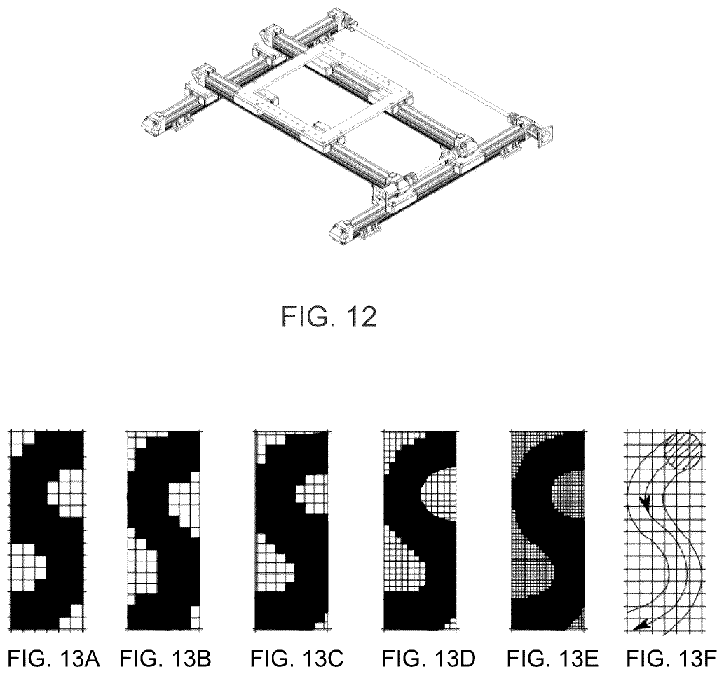

A single pixel pitch per print or per layer is limiting and results in a requirement of pixel mapping; during the design process, aligning features like channels and pillars must be made at the same intervals as the pixel grid. However, according to the current invention, pixel size can be changed before, during, or after printing, including during a layer. By integrating the ability to adjust the pixel aspects and mounting the projector on an XY gantry (see, e.g., FIG. 12) and adding a rotation stage (see, e.g., FIG. 19), the current invention allows for effectively decoupling the printer from any pixel grid and introduces several novel concepts.

### Scanning or Trace Mode:

In addition to the above, as shown in FIG. 13A-F, if a single pixel or a group of connected or unconnected shapes forming a specific block of pixels were turned on at one or varying intensities to enact a solid or dimmed/unfocused dot, the gantry for the projector could be used to draw a shape on the exposed layer (FIG. 13F). This means the projector can essentially work as an SLA machine. The pixel group could be directed to several areas and create an array of the same object, or used instead of a second exposure to trace the leading edge of channel/void transitions. This inventive technique can be applied for creating smooth curves in the structure in the Z direction, in place of 3D anti-aliasing typically used or in addition to shrinking the pixels to smaller levels. The shapes could be independent from one another, or connected to each other. Features created can be independent from the pixel map of the DLP/LCD, but also not the same as the SLA-it can be a hybrid design. This would enable smooth lines at the micron level, curves and circles with hollow sections, and the ability to make blocks of these features (for example multiple cylinders created with different wall thicknesses), which is exceedingly difficult to do via LCD/DLP, even with dimming resolutions technologies. The gantry example in FIG. 12 is non-limiting, and several examples of gantries exist, including, by way of example: core-XY, Cartesian, polar, and delta. It is envisioned that a polar gantry would find particularly beneficial use in the creation of devices similar to CD-style microfluidics.

Mosaic and Tiling with Various Pixel Aspect Sizes:

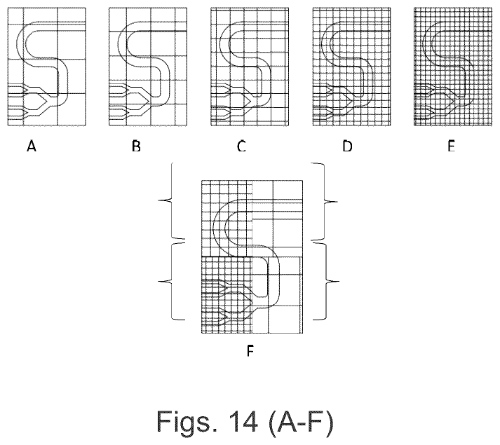

FIGS. 14A-F illustrate a common microdevice scenario of a circuitous route and branched or bifurcated channels which reduces the span of a channel with each split. This presents an issue for high-resolution 3DP DLP because the ultimate size of a build area is directly tied to the DMD x pixel size (e.g., 2K, 4K, 8K). FIG. 14A illustrates that some parts of the larger channels may be printed but others will not turn out correctly in the curved sections. FIG. 14E illustrates that all aspects of this layer may be resolved; all aspects of the bifurcated channels and route may be printed. However the cost in FIG. 14E is a very high number of exposures per layer which increases total time to print. FIG. 14F shows that more than one pixel size can be integrated for a given layer. For an exposure, the total area covered is multiplication of the total size of the pixels (e.g., 10 um) by the total array size, e.g., 4K is 3840×2160 pixels in X and Y. In this example, the total area for an exposure would be 38.4 mm×21.6 mm. If the size of a print dictates a larger build area, the pixels must be scaled up (say by around 50 um). However, if the features in the layers are too small (e.g., around 60 um width channels in this particular example), they will not be properly resolved, because, typically, smaller pixels are required to produce detailed features, however it reduces the total print area the printer is capable of.

According to the current invention, to print small features over a large area, the picture or image slice can be converted into a mosaic of sub-slices. This can be accomplished by software capable of creating sub images or cropped images via scale size (e.g., vector analysis) or pixel count (e.g., raster/bitmap, PNG etc.). According to the previous art, in aspects, when this is done, all mosaic tiles are the same size, and all pixels remain the same size for the layer and the print—e.g., 10 ums with 4 exposures of the same durations for the different sub-sections. With scalable pixel aspects according to the current invention, that, in aspects, is not necessary, and the current invention allows for faster printing times. By way of a non-limiting example, the preferred pixel can be selected for speed and resolution (e.g., 5 um with 8 exposures), or in the case of only a small area needing high resolution-a single exposure at very high resolution can be displayed while the rest of the layer can be created by one exposure, e.g., FIG. 14A shows this can be completed via 20 um at 2 exposures, one exposure with 10 um pixels, and 2 exposures at 5 um pixel aspects.

According to the current invention, this can provide for especially useful printers, which can span several measurement factors. From nano to macro, this current system can enable the creation of large (macro) objects centimeters to meters large, along with microscopic features in a much faster production method. As Manufacturing as a Service (MaaS) grows with the Industrial Internet of Things (IIOT), the current invention is an improvement over the current art for the microfluidics and lab on a chip industry, currently limited by expensive molds with long lead times.

Taken together, FIGS. 14A-F illustrate many scenarios can exist where a particular layer or design may be best served by multiple pixel arrays in size. This can occur at many different layers, that one layer may be simple enough to only require one pixel aspect and exposure for the layer, and that an incredibly detailed layer may require more than 2-pixel sizes. Further, as pixel sizes shrink, the intensity and lumens or photons per unit area increase, increasing the dosage per unit time; this affects cure rate and cross-linking of the polymer and should be considered in design and fabrication.

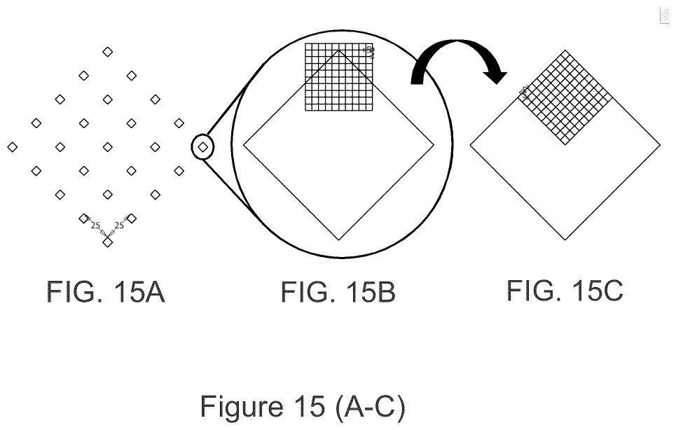

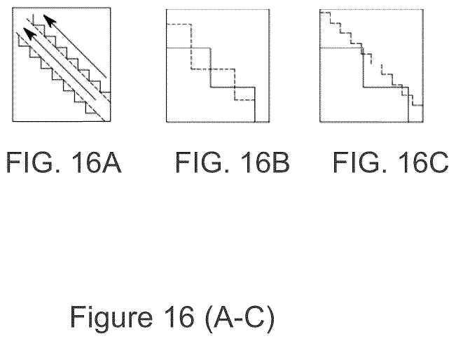

Further, FIGS. 15A-C show that particular designs-such as a diamond pattern used for cell separation (FIG. 15A) which uses squares turned at 45 degrees to the main axis of the DMD (FIG. 15B)—and other designs which have non-orthogonal lines may be better served by rotating the projector to this aspect (FIG. 15C) and printing these features rather than using another strategy like extremely small pixels or grayscale methods to emulate this section. Finally, in aspects, this process is not done in one exposure, therefore these mosaics can have pixels in a variety of sizes, sometimes more than 2 or more than 3, and thus can be printed in any order deemed fastest or otherwise optimum; this can be completed by computer-based decision making. In aspects, an algorithm may be used as a decision maker for the mosaic tiling on a per-layer basis and may be made in real-time or as part of the initial slicing program.

Shift: The projector with a well-equipped gantry, XY, with a leadscrew stepper motor and linear rail set may shift the location of the pixel array by a portion of the pixel pitch and use a second exposure or during the exposure (see, FIG. 16A) to enact the effect of reducing the pixel in half (see, FIG. 16B and FIG. 16C), ¼, ⅛, etc. (See, FIG. 16). The pixel aspect to remain the same and the projector location relative to the first exposure shifted to allow a percentage of overlap-mimicking and creating for all purposes a smaller pixel than possible on the original optical plane. This is a method by which to replace, enhance, or expand the greyscale methods in previous art.

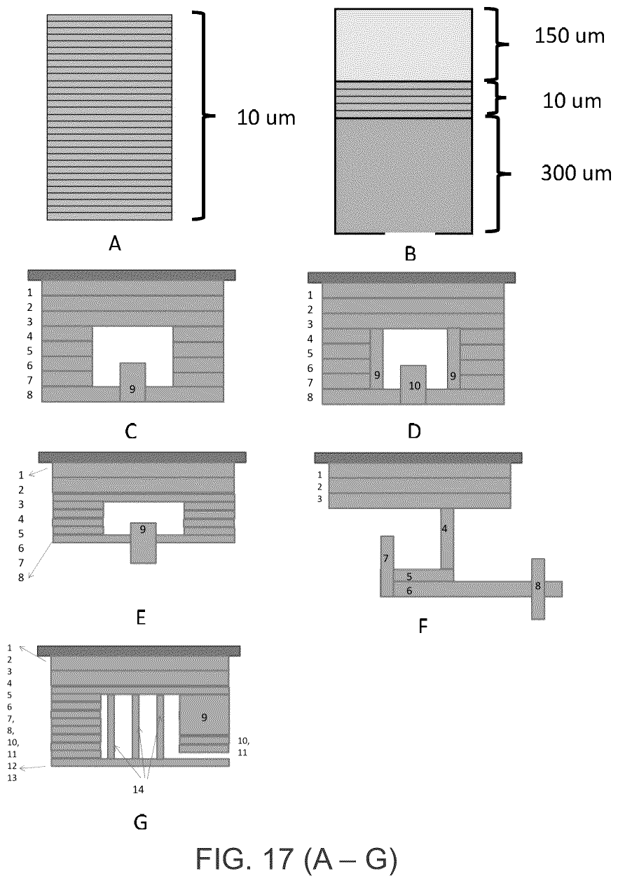

Expanding on this aspect, the pixels can also be expanded to print larger sections more quickly; especially in some layers for uF devices the actual layer has lower tolerance requirements—for example the base layers in many devices are a slab which have no channels. In this case, completing the layer in one exposure-especially if several layers are the same-can have a significant shortening of the total print time. In total this could reduce the number of actual displayed areas per print per layer. For example, in FIG. 17A all 30 layers are 10 um in height, this would take 30 repeats of exposure plus peel motion. However, with different filters it is possible to expand the range of 3D printing resins to 250× (e.g., 2500 um) the penetration of standard light sources and high accuracy resins (e.g., 10-25 um). FIG. 17B shows a scenario of using 3 filters to allow three different tuned heights of 10 um, 150 um, and 300 um. This represents a significant reduction in print time as only 6 layers needed to be printed in FIG. 17B vs. 30 in FIG. 17A. This can also be combined with the “trace” described herein and use an edge of pixels to trace the channel or other feature. It can also be combined with different print heights and penetration into zones of previously printed layers, allowing new capabilities of liquid-based printers to yield solids which would have been considered unprintable before, because in the past, these “islands” would have been printed unsupported and would not have been attached to a solid body via a part of themselves or additional supports. This is shown in FIG. 17C-F. In some cases where extremely thin pillars or walls are necessary, but due to the delicate nature of printing several layers of them might cause print failure, it is more advantageous to print when they can be attached on top and bottom in one exposure; this technique is illustrated in FIG. 17G.

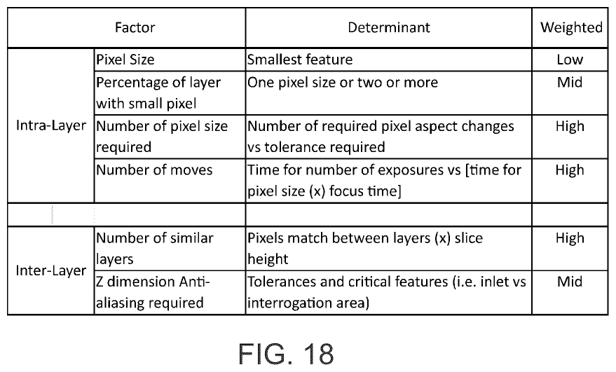

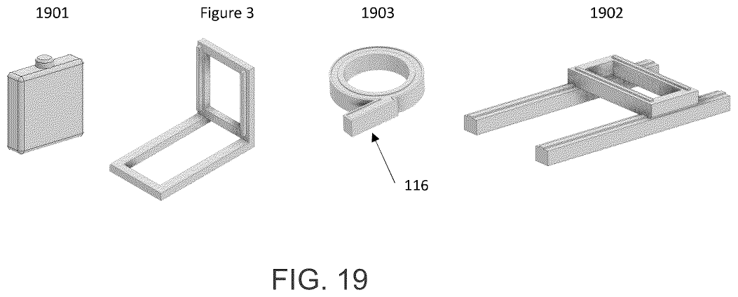

The combination of aspects of the invention described herein, or any aspect used by itself, can allow the completion of high-resolution prints faster. In aspects, a computer algorithm with a decision matrix can be capable of creating a format to derive this method for any print, and any segment of a mosaic or layer within a print, and can be incorporated to the slicing engine of that program, routine, sub-routine, etc. FIG. 18 illustrates a decision matrix which can be used according to the invention described herein.

Parts of these algorithms can be used with a different 3DP by placing a gantry for the vat and build elevator on a standard LCD printer or SLA printer, which has the ability to shift in XY at sufficient resolution. This process could be enacted on these printers as a way to retrofit or otherwise improve their functionality. For example, Anycubic Photon™, or Phrozen Shuffle™, or in the case of an SLA printer, FormLabs™, are examples.

FIG. 19 shows a representative schematic exploded view of the projector (1901) with focus apparatus and zoom gantry (detailed in FIG. 3), mounted to a rotational stage (1903) with stepper motor (116) and then mounted to an XY gantry (1902) with a mounted projector stage. The stage also can have a Z motor (see, e.g., FIG. 3) as well as a focusing apparatus. By using a combination of lead screw pitch and number of steps to the motor stage movement of a few hundred nanometers can be obtained while the pixel size remains at 10 ums. Piezo stages can reach tenths of nm. This could allow the use of pixel resolution to still be at 10 um (2× pixel size) but enable movements of for example 10 mm-0.200 um; meaning that the effective pixel size can be stepped at any non-static selected interval chosen within that range. In this non-limiting example, if 200 nm step sizes per layer were selected, the next pixel size up which could be completely rendered would be 10.2 nm features, and stepwise at every 200 nm spacing from there: 10.4 um, 10.6 um, 10.8 um, and so on. This feature size increment is lower than possible for injection molding, hot embossing, and PDMS molds. The resolution of nanometers is at or below the typical threshold for surface roughness for these processes. As well, it approaches resolution for 2PP, which is in the 50-100 nm size range. Further each step could be a different number as determined by operator input for resin or computer algorithm.

### Resin:

### Filter Based Depth Control Per Resin Constituents:

In microfluidics and other microdevice fabrication needs, one of the most important parameters is the ability to control the cure depth (or light penetration) and understand how to do so. Factors that affect the control of depth are wavelength of incident light (bandwidth), intensity (light Flux, Lumens, or number of photons), the chosen photo-initiator (which when activated initiates the polymerization reaction), the photo blocker (which inhibits the transmission of light at certain wavelengths), and the monomer(s)/oligomer(s), with other dyes, additives (ceramic or metallic) particles, and potentially plasticizers.

The “polymerization band” is the bandwidth where the light source spectrum and the photoinitiator absorption overlap. In clear resins, the cure depth is controlled mostly by the photoabsorber that serves to absorb the light and eliminate the ability of the photons to create a broken bond. This is the segment of a light spectrum that allows reaction and subsequent polymerization between the incident light, and the resin constituents (e.g., photo-initiator (“PI”), photo blocker (“PB”), and polymers). Within this range, incident light (referred to as a bandwidth) activates the photo-initiator via photon absorption and subsequent bond breaking. This creates a free-radical state, and the charged segment of the initiator seeks to lower its overall charge by linking to a monomer, creating a polymer. This chain reaction can continue until the energy state of the polymer is sufficiently low and further linking to other monomers is terminated. The number of the reactions/broken bonds (the reaction speed) is proportional to photon Flux, the absorption level of the PI and PB, and the PI type and number of radicals created during bond breaking; a larger number increases the temperature of the solution (exothermic reaction) until all the catalyst and reactants are exhausted, in examples.

A priori, light bandwidth, and the photo-initiator must, typically, share some portion for the PI to be activated. In the case of clear resins, where there are no dyes, coloring, or particles that would block the light beyond the photoblocker, there are three interesting and separate scenarios:
1. No overlap of the curing photon source with the photo blocker, which would result in an exceptionally large to infinite cure depth depending on the intensity and extinguishing/absorption rate of the polymer on the bandwidth.
2. A specific and limited overlap between the PI, PB, and bandwidth (“BW”), which would result in controlled cure depth. This scenario can be experimented with to determine exposure times for a given depth and is the typical scenario for most 3DP resins.
3. A general overlap between the PI, PB and Photon source, while the absorption rates of the PI and PB vary in intensity. In this scenario the different absorption rates vs. photon content allow one of these constituents to be the limiting factor between unrestrained cure depth—and very limited cure-depth.

FIG. 20 shows a set of several different curves of resin components investigated for the current invention, BBOT, TPO and the unfiltered light source (aka, Spectrum). The shaded areas are ranges for each filter in A filter 1, in B Filter 2, and in C Filter 3. The range each filter allows to pass through from the original light source are the resulting bandgap or bandwidths that can reach the vat window and polymerization zone between the top of the vat window (made of a UV transparent material such as FEP, PET, or glass). As can be seen in FIG. 20, the ranges allow for different sections of each curve, wherein each material may have a different affinity and hence control over the resin curing dynamics of speed, depth, and cross-linking, thus filter selection may be used for cure depth control. These filters represent only some of the wavelengths/filters experimented with and available to researchers in this disclosure according to the current invention. Again, LEDs, LED arrays, lasers, and other bulb types, are all envisioned to be applicable within the scope of this disclosure herein to use multiple different bandgaps and wavelengths at different times to yield different print cure depths and speeds for 3D printing. Additionally, using a filter with one or more LEDs adds control over their accuracy due to known stray light emanating beyond the specified FWHM central wavelength.

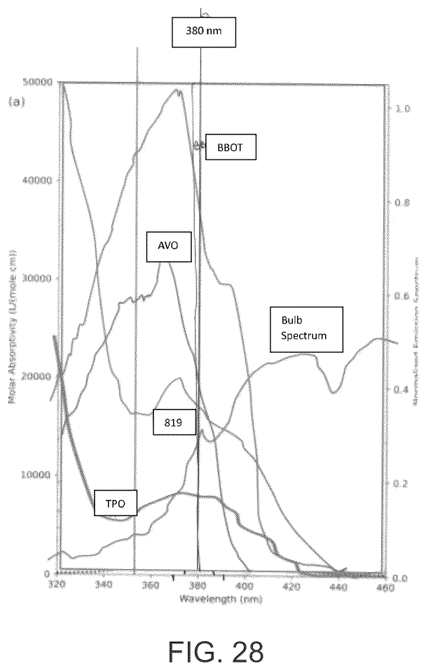

Regarding the area of the curves between these two states and within the range of the light source (2003), the two curves of BBOT (PB) (2002) and TPO (PI) (2001) have nearly identical maxima at 362 and 372 nm, respectively. As the two curves follow light into the near visible segment of UV, they separate. TPO extinguishes faster than BBOT but still has residual blocking power albeit reduced over Igracure 819, as shown in FIG. 28. What was discovered, according to the current invention through significant iterative experiments, is that this segment where significant overlay occurs still allows controllable cure depth, and that if bandwidths are preferably selected/chosen, different cure depths for a particular filter can be attained which are outside of other filter/bandwidth combinations, which is new and novel when compared to the current state of the art.

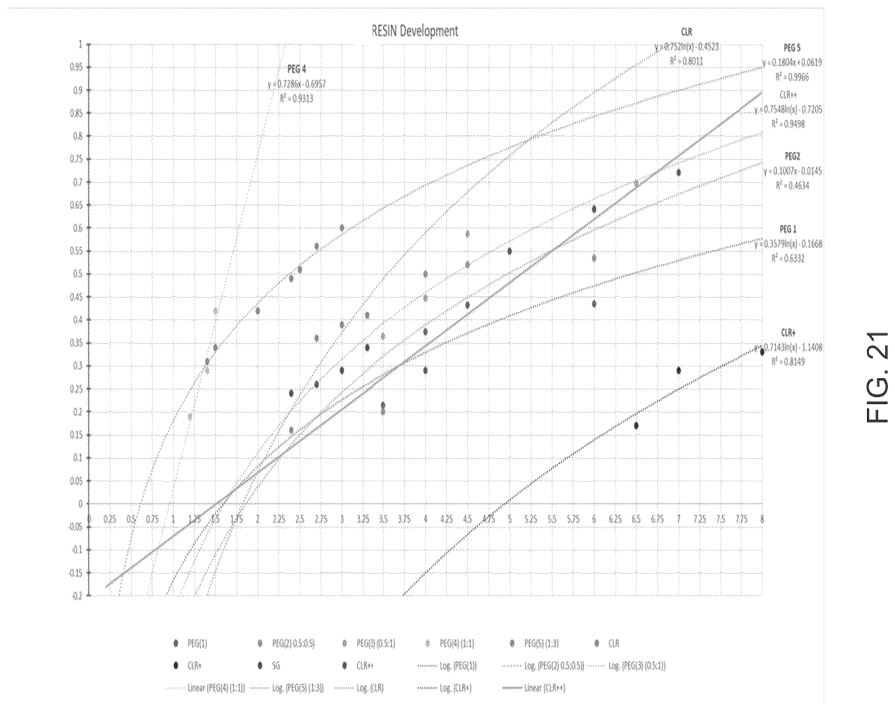

This discovery as part of the current invention allows for the accurate curing of different cure depth ranges that have overlaps but not in the complete range. Thus, microchannels are possible at different regional spectral positions (bandgaps), and different spectral positions or bandgaps selected via filters or light sources (e.g., LED(s), laser(s), or combinations thereof) can be programmed into a 3D printer program to effect different layer heights, channel openings, voids, solids, other structures, etc. FIG. 21 shows the different cure distances for a single filter with different resins-illustrating that different combinations and concentrations of UV blockers and UV blocker types result in different curing distances per unit time or dose.

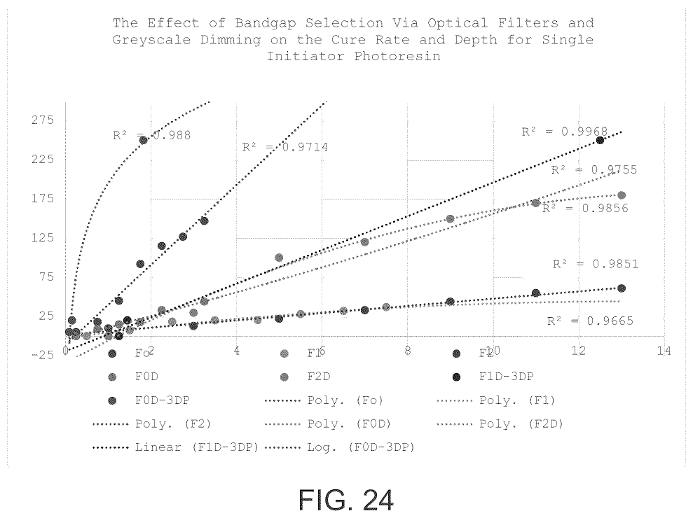

To enable small voids and thin layers to be printed in a controlled manner, such that a void printed in a previous layer will not be cured during printing of subsequent capping layers, for example, it is necessary to enable a low slope curve in this example plot. In FIG. 24, seven different filters were used (glass slide with Filters 1, 2, and 3, glass by itself, and the filters by themselves). The filters were changed in each case by using the movable shutter where filters have different positions between each print; this can also be controlled during a single print on a per layer basis, an intra-layer basis, at multiple times per layer; in cases, all filters can be used, no filters can be used, one filter can be used, and variations of the above. The combinations are plotted using the same resin in each case. Conclusively, FIG. 24 shows that controlled mathematically-matched cure curves can be elucidated, and that they can be used to understand and predict the rate of cure and the depth of cure by using different filters. This means, in aspects, different layer thicknesses at different exposure times are possible, as is the control over the crosslinking density within that printed region depending on filter selection. This then allows for the printing of multiple “sliced” layers at once in a “block” or “chunk” if the layers in that region are sufficiently the same, in aspects. With this knowledge and a rules-based algorithm as explained herein, for example based on the hierarchy described in FIG. 18, a computer program is capable of enabling faster prints, skipping layers, or using what can be described as Dynamic Layer Heights.

The current Applicant, according to the current invention as described herein, investigated several PIs, PBs, and band gaps which span the range from 365 to 405 nm (e.g., 365, 385, 395, 405 nm). Until the current invention, Applicant is not aware of any DLP projector-based system that has been able to produce channels or artifacts at a 10-20 um range using a mercury bulb or bulb with filter. Further, the research reflected herein shows that using a filter to tune an LED or laser via “cleaning up the spectrum” is better than individual LEDs.

According to experiments that led to the current invention, it was demonstrated that a standard DLP light projector 3D printer with proper resin construction and bandgap filter selection can readily produce flow channels at and below 100 um, down to 80, 70, 50 microns, and below using these techniques of different bandgap filters for tuning an originating light source; according to the present invention, this can be expanded to encompass multiple LED channel arrays. LED arrays with more than one bandwidth can be selected (e.g., 325, 365, 385, 395, 405). Further, for additional control over cure depth, the selection of bandgap and mated PB can be governed by the difference in absorption rates of the two. Further, this difference can dictate which filter, or LED, should be selected/used based on the percentage of PB within the monomer, allowing for adjustable cure depth. It is the bandgap photon content (Flux) and percentage of PI with a matched absorption spectrum that can be used to control reaction speed and layer cure depth, in aspects of the current invention.

Custom optics can be used according to the current invention, adding filters that can attenuate the wavelength within the polymerization band and allow preferred penetration and cure depths. In aspects, PEGDA 250 MW can be used as the base monomer. The photo blockers investigated by the Applicant leading to the current invention were BBOT, Tinuvin-400, Tinuvin 477, Tinuvin 384-2, Tinuvin 1130, Avobenzone, and NPS. The photo-initiators used were Igracure 369, Igracure 2925, Igracure 819, and TPO. In examples, Applicant used a 10 um pixel size on the Optima UHD60, which has a 4K DMD, as such the total build space in this case was 38.4×21.6 mm. FIG. 5D shows the measured light spectrum of the Optima HD60 4K projector with a standard bulb. It illustrates that the light spectrum starts in the UV with overlaps on all PI listed above and continues through the UV and into the visible light spectrum. The amount of light at each selected segment (see, filters from FIGS. 20A-D) is the integral of the band gap to the maximal of the spectrum in this range; filters used were Thor Labs™ FGUV5, FGUV11, FGUV9 generally cutting off light at 365, 385, and 395/405. Their flux pass rates are provided in FIG. 5A-C. As each filter is not 100% pass rate, the flux is reduced across the selected band gap. As part of this unpredictable art, surprising success underlying at least in part the current invention described herein, was reached when there was a high enough flux and absorption overlap to solidify the chosen resins with the filters listed, according to embodiments.

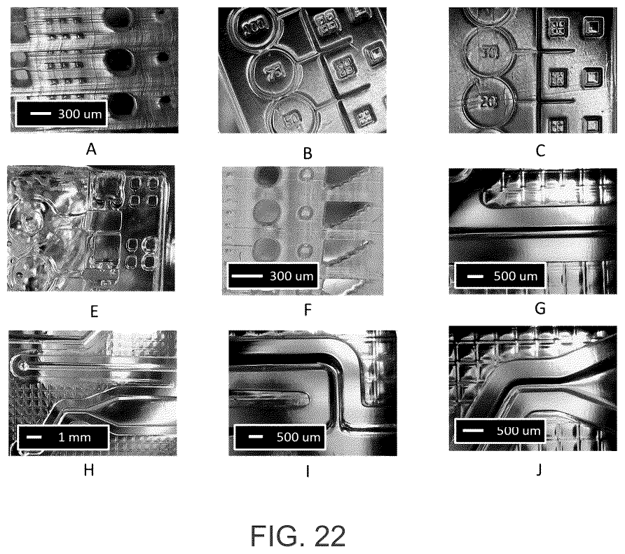

Experiments showed that even with extended times of exposure, into the tens of minutes, the filtered light which coincides with different parts of the molar absorptivity in curves of PI and absorber result in different thicknesses of layers which can be polymerized. The results for, for example, filter UV11 and BBOT/TPO are exemplary of tunability as compared to UV5. The experiments explained herein are more comprehensive and provide a deeper understanding of the resin and how each constituent performs differently when others are also a factor in the experiments. This is useful in several 3DP scenarios to reduce the time of a print while attaining a high degree of accuracy for micro-features (see, e.g., FIG. 22A-J, where the images show channels ranging from 10-500 um and capping layers allowing cross-hairs of these channel sizes to be shown). FIG. 21 shows a graph with different compositions of resin, illustrating control over the depth and time for cure, including below 20 um.

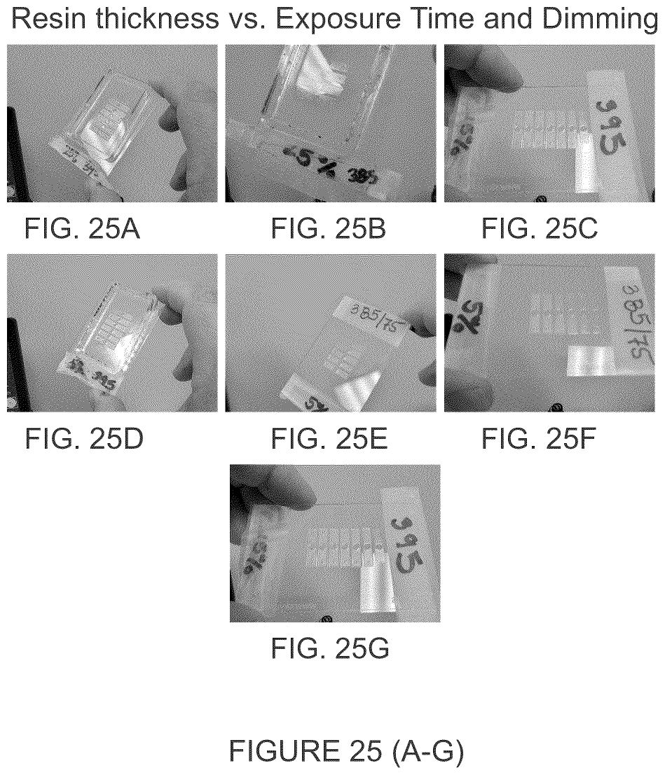

The results of experiments with absorption from blockers, initiators, exposure times, dimming of edge band pixels, overall channel height, and light sources, is demonstrated in FIG. 22, showing microscopy images of crossflow channels. A 3D representation of some of the close-ups in FIG. 22 are shown in FIG. 27. The FIGS. 24 and 25 (A-G) further show that choosing different bandwidths of light source does indeed change the cure-depth regardless of exposure time while maintaining that a cure depth is an exponential decay function and follows the Beer-Lambert Law. It was theorized by the Applicant according to the current invention that this could be explained by intensity or dosage-so several experiments were run into the 10, 15, and 25 minute range. In aspects, there were no further depth penetrations beyond the shown graphs.

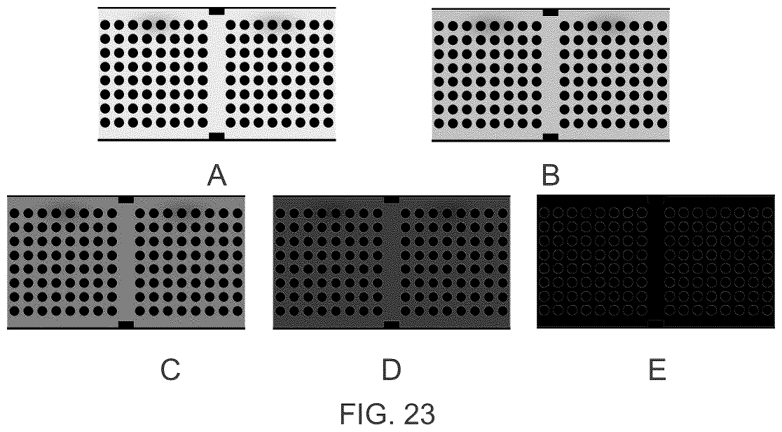

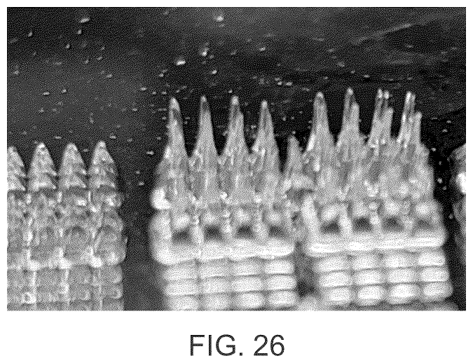

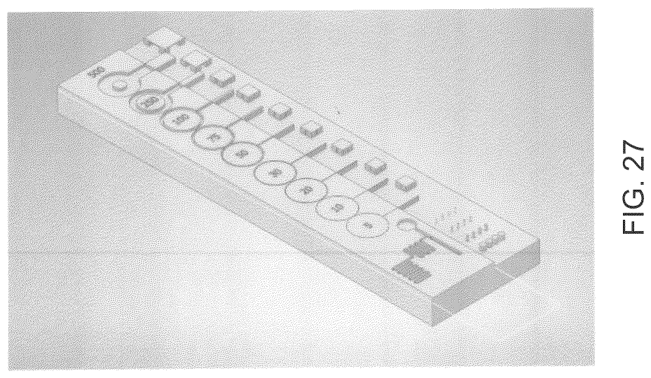

According to experiments as part of the current invention, it was discovered from using different filters that the cure rate and ultimate penetration distance were controlled via the wavelength of light allowed to pass from the original spectrum of the bulb to the working plane (polymerization zone). To classify this phenomenon, three experiments were completed.
1. A glass slide with plastic attached via adhesive was filled with resin. The glass slide was placed over the FEP in an empty resin tank and a series of single exposures of different times was used with the three different filter positions: Filter 1 (Thor Labs™), Filter 2 (Thor Labs™), and open. The glass slide was expected to limit some UV light and thus affect the penetration curves. These curves are plotted in FIG. 23.
2. An array of a series of squares with different total square areas were exposed for different time periods. A glass slide was loaded into the 3D printer and the resin vat filled. A single layer was printed on the glass slide at different starting heights to determine the cure distance of a survivable layer. The total number of square sets being 20 in this example, a highly rendered curve for the time period. These results also showed the differences in filtered light or bandwidth can be used to control cure depth and cure rate. From these original results, a series of test wafers were designed and tested for different time and dimming intensities across a single exposure in order to tune the dosing and enable even cure across a layer; these results are shown in FIG. 26. These results show that for the same duration in time, different filters with a tuned layer in greyscale can produce an even layer of varying heights. Further in FIG. 26, the ability to create micro-needle arrays via a single exposure is shown. In aspects, these needles measure 500 um on a side, are 2 mm tall, and take less than 2 minutes to produce-all while exposing a single image with a tuned light source to the resin. This is accomplished by using a glass slide with a plastic outer ring cut and bonded to it. The well plate is filled with resin, and a single exposure (a series of exposures or movie can be shown) with no elevator or build deck required, can complete this array of needles in times ranging from 10 to 120 seconds. This is a vast improvement over the formerly required, for example, 100-200 exposures and movements to create such delicate features, which can be damaged during the peel-steps.
3. A calibration slide was developed to enable a single machine run to analyze the influences of and between the process inputs of total feature size, exposure time, dimming percent in bulk, and edge pixel number (1-5), on the cure rate and crosslinking density as the model transitions from void to solid (the edge-bulk region) in both directions from solid to void, enabling enhanced tolerances and the understanding of and the control over light bleed, or over cure. This is especially difficult and critical in the transition areas vs. bulk dimming percentage. The transition area, in aspects, can refer to within 5-10 pixels from the edge of solid-void in both directions. There are scenarios where there are fewer than this number of pixels when describing the transition zone (or edge of a solid or wall) for bulk areas where the number of pixels are greater than 5-10 pixels from the first non-zero pixel row (solid) next to a void (zero value pixels).

The results according to experimentation underlying the invention described herein, show that different filters, different substrates like regular glass that filter UV light, and different wavelengths of the spectrum acting at the working zone (polymerization area), enable a user an additional level of control beyond the spatial patterns typical in 3D printers by using patterned light through LCD pixels, DMDs, laser spots, etc. It enhances and allows precise control over penetration distances at an incredibly varied rate. These results show that (1) FIG. 22-24 depth control for a single resin is possible via multiple filters to control light spectrum, (2) FIG. 22-24 show that depth of cure can be calculated and result in a programmable method that can keep open cavities, channels, etc., of different tolerances.

With these advantage according to the current invention, a set of algorithms was developed to enable the computer to, among other things, (a) sort each slice/layer based on how many replicates there were, and (b) determine if it was (1) a “capping layer” or (2) set of layers on top of a void, (3) a “Base Layer” (or “Initial Layer” used to adhere to the build plate and due to the metal clips on the Chip-Clip would need to be at least 250 um thick, in examples), (4) a “Passive Layer” (or layer with no voids), (5) an “Active Layer” (or a layer with features required for the device functionality), and/or (6) a “Curve or Ramp” Layer or and “Island Layer”. The 3D printer fitted with the shutter and 3 different positions for filter, wavelength selection, or bandwidth allowance, used the filters depending on the total number of layers multiplied by the slicing height to determine the exposure time. These algorithms resulted in a reduction of total number of PNGs being needed per 3D printer, allowing for lower memory requirements and faster slicing times. It also reduced the total number of exposures for every object to be printed while enabling high tolerances to be preserved such that the final model printed remained faithful to the original design tolerances—this is important to the implementation of microfluidic and microdevices in general.

Because of the differences in cure distance, cure time, and the reduction in the number of layers (and hence number of peel steps between each exposure), the total time to print a device was significantly altered as well.

Generally, the total time for a single device was reduced by a factor of 10, in examples. For example, three example files having a single active channel were reduced from 20 minute to 2 minutes (the bulk of this two-minute time was the travel time, a total of 44 seconds, for the elevator moving from the load position at 55 cm above the vat window to home to start the print, and then returning to the loading position after the print was complete). A third example device which took 4 hours to complete was reduced in total print time to 45 minutes. A fourth device was reduced from 2.5 hours to 22 minutes. The larger the number of layers that are the same, the faster the printer can run. The machine and settings for fast-deep cure showed the printer was capable of curing to a depth of at least 10 mm, although some resolution was lost due to optical focal plane. A fifth device was an array of 825 microneedles, 500 um at the base to 0 at the top, an 1 mm tall. By printing this structure from the bottom up, only a series of exposures allowed the needles to be printed directly to the substrate with no peel steps in less than 10 seconds. The experiments went as far as testing 1 mm thick sections with 1 mm vias in a single exposure, to keep within the focal plane of the lens pack. This resulted in a current optimum printing range between 250-500 um, with 250 being selected due to residual resin stress from polymerization of thicker layers vs. thinner.

The results show that while an original 5 um layer with a tuned filter was printed at 5.4 seconds with F2, for the best resolved filter to allow the thinnest layer possible, an additional 4.8 seconds was required between each cure exposure to allow resin to reflow under the deck for the next layer (peel step), which resulted in a total of 10.2 seconds for 5 um height, or 1.76 mm/hour. Similarly, but slightly faster, the F1 filter had a print time of 2.4 seconds with the same peel step for 10 um, or a 8.57 mm/hr vertical print speed. The F1 filter selection would not allow thinner than 10 um layers with an open channel below at less than 50 um. The resulting print speed of F0 at 250 um per layer is 315 mm/hr and 1260 mm/hr with draft mode where tolerances can be lowered. Overall, a reasonable speed increase of 180× faster between 5 um and 250 um speeds was observed. Results for the F0 filter selection show printing with only this filter would cure all layers below it as well regardless of layer height selection up to 50 um. Ergo, multiple filters can be used in a print to enhance speed and reduce cycle time of 3D printers while retaining high tolerances required, according to embodiments of the present invention.

Generally, in high definition prints where horizontal channels and interconnected, internal voids are required, such as in many microdevices like liquid based microfluidics or even back filled connections such as gallium and silver based conductive inks for microdevices. In aspects, there is a hybrid effect. To utilize this new attribute, several algorithms were developed based on Machine Learning, comparative graphics algorithms, and vision tools, to train the printer to go fast or faster when tolerances and geometries allow, and go slow or slower where high tolerances are required or channels need to remain open to post flush-because other filters would over-penetrate and solidify resin in channels below the current layers.

In practice it was found that this method of hybrid-layer heights or dynamic layer heights can increase printing speeds from 10-100× for a given design over standard DLP printers. When compared to manufacturer claims for Carbon CLIP™ technology, it is 6-60× faster. This is because while this particular method embodiment does have peel steps-it can essentially skip layers or print up to 1000 at one time. These attributes of speed, accuracy and precision allow 3D printing the required metrics to usurp manufacturing for a particular area of the ecosystem-microfabrication of high precision plastic parts such as those required for computer connections and plugs, microfluidics, lab-on-a-chip, and others.

As such, there is an issue with systems which use a single LED curing spectrum with a PI and PB which completely overlap. In such cases, as the team at BYU and Nordin have noted, there can be no further curing of the layer after initial layering; meaning that the light which is needed to cure cannot penetrate further than a certain distance regardless of how long it is exposed for. Therefore, sections below this critical distance for single LED methods remain at a green-state cure. This presents a problem as PIs, monomers, and raw resin constituents are known to be toxic to target cells and leach out into the channels. As such, this system of a PI and PB have decreasing distance between absorption curves on one end of the curve and may be cured to a final state after initial polymerization.

For example, generally speaking, a resin matched for 365 nm will not have the same cure curve (the same depth of cure at the same rate) as 405 nm, regardless of allowing it to be exposed to that light bandwidth for minutes (or hours)—the initial cure of 100 um takes as little as 3 seconds but beyond a certain distance (z) the resin never cures. This is further illustrated in the experiments depicted in FIG. 24, and combined with the curves of exposure times vs. cure depth in FIG. 21, FIG. 24, and FIGS. 20 and 28. The review of the combined data allowed the Applicant during experiments to calculate the settings for the above. This shows that selecting a bandwidth, based on the required layer height to cure several layers at the same time, is directly proportional to the differences in molar absorptivity between the PI and PB (resin absorption spectrum), allowing predictive cure depth based on user preference. To illustrate this more completely please review FIG. 5E-G, which shows the light spectrum of the mercury battery overlaid with curves.

At least part of the novelty according to the current invention is that the spectrum of the light source Hg-bulb is not completely contained within the bounds of the photo blocker, such as situations which use single channel LED light banks. In aspects, nor does the current invention use the second set of PI. But, according to the present invention, by selecting different filters to tune the light source to selective bandwidths and having different exposure times and slicing heights, the resulting solid form is different from what can be obtained from a single LED channel. In addition, according to the present invention, it is the tunable depth of cure on a per layer which enables some devices to be printed at all, as without this advancement complete conversion of resin constituents would not be possible with a single PI, nor would it be able to actually print the device and have the initial layers bond to the substrate. Further, according to the present invention, two filters could be used on one layer with different patterns and different exposures allowing different cure depths in controlled and programmed areas. According to the present invention, a projector with a bank of LEDs or a bulb-style projector with auxiliary LED bulbs is also possible that spans these critical spectrums for a single resin.

### Dimming Algorithms:

Applicant also experimented with dimming pixels inside of the areas for fine tuning the resin curing rate between bulk solid, void, and transition layers. For example, it was found that using 1-5 pixels from the edge of a solid/void at full brightness while reducing the internal pixels from at least 20% up to 60% for this particular resin, enabled the Applicant to resolve down to 10 um open channels and 50 um closed channels. In many of the current LCD printers, the dimming algorithm can only be applied to the exterior of the illuminated object, which is a poor solution, in examples, for microfeatures as this erosion changes the tolerances significantly.

The basis for this solution of the current invention is from several points:
1. Tolerances at this level of precision are extremely difficult to adhere to.
2. It is documented that larger objects in a layer take a shorter time to cure than smaller ones.

With a single intensity across an exposed frame, the interior of objects that are wider than 5 pixels generally cures faster than the edge, as it has surrounding neighbor pixels which are illuminated.

There are several novel attributes this approach allows. Images of the settings and resulting PNG files can be seen in FIG. 23A-E, which documents the difference between non-dimmed (a) and dimmed at 4 pixels wrap at 10% (A), 25% (B), 35% (C), 75% (D) and 90% (E) with a homogenous dimming on the infill. It was discovered through experimentation that these different greyscale settings allow the walls to cure substantially as fast as the interior bulk areas. Without this technique, the walls and other smaller square area features like pillars may not polymerize as quickly as bulk, and can lose tolerances or create light drift/overcure into the small voids and channels.

By combining the greyscale into one slide, it reduces the number of exposures used for a given uF device height, shortening the time needed for a total print, as well as decreasing the file sizes needed to be created. Examples of how well this works can be seen in FIG. 22 B, C, and G-H. In FIG. 22 B-C, it depicts an illustration using the greyscale or dimming technique. In FIG. 22 G-J, a 50 um channel grid is the background for 300 um channels and 500 um walls. Note that no pixel artifacts (small grid or surface roughness) are visible.

All objects regardless of the exposed area can be tuned to have the same cross-linking conversion rate or can be custom tuned to have lower areas for better adhesion and bonding to subsequent layers. This is true for most resins for dimming percentages tested between 2% and 50%. In testing examples, at lower than 20% the resin documented herein does not cure fast enough, and at greater than 55% this particular resin begins to have effects on green-cure stability and survival for the next layer-specifically, it begins to delaminate and prints fail.

Different patterns akin to infill in FDM, (such as concentric, hatched, hexagonal, checkerboard, etc.), the frequency of the pixel bands (e.g., 2, 10, 100 um), and dimming rates if above 55% on the interior of layers, can result in a customized surface roughness based on exposure time, pixel activation, and dimming percentage outside of definitive programming in the original CAD model. This can allow for micro and nano surface texturing to be rougher within channels than can be attained with a standard single setting layer. In the case of passive mixers, one of the main modules or requirements in designing a microfluidic device is to integrate two liquids quickly, as this process can enhance the mixer.

These patterns, textures, and/or surface textures, can be activated on a per-layer and per-mosaic (inter and intra layer) basis and can be programmed via an algorithm. For example, if a channel is to be formed with a higher roughness in one area, a look ahead comparison via python code can detect the area on the current print layer which will become the channel top by comparing it to the next layer. It then creates the selected pattern at the selected dimming percentage and exposes only that area for that dimming pattern leaving the rest of the layer to be cured at a different level of dimming. This algorithm can be pre-programmed into the “resin recipe” or “resin profile” or slicing algorithm and thus create several customized profiles for each resin depending on the surface roughness required.

Herein, in embodiments, we describe how a single print may be printed faster and with more precision than previously allowed.

Further, custom tailoring of initial layers for bonding is also one of the issues facing printing devices for low post-processing and direct use. The initial bonding to develop an attachment to the substrate or build plate, in this case, a salinized glass slide, is difficult and usually these layers are overexposed. In the current state of the art initial layers are over-exposed to create a strong bond. This causes a problem in that the longer exposures cause bleeding at the edges of the model and the spreading of resin which is polymerized. This is termed “elephant foot” because it looks like an elephant standing on its footpad which expands under its weight. In the case of uF which typically use one or more of top or bottom of a device, this causes a device to have issues outside of tolerances.

According to the current invention, in embodiments, further compromising the current set up, is the use of the Chip-Clip™ slides. In aspects, the metal clips that hold the substrate in place are 350 um in thickness. The 385 filter (THOR LABS UVS™) high-resolution resin does not allow light to penetrate into this resin deeper than 100 um with the filter in the range extending to 385 (FGUV9); to penetrate that deep the FGUV5S (395/405 nm) filter should be used, in aspects, and/or the open filter which has light content into and beyond the visible spectrum should be used. To improve upon this even further, the current Applicant according to the present invention investigated through research and development a vast number of settings for the initial layers and found that by dimming the initial edges to the layer by 35% or more of at least 2 pixels, by way of example, several novel inventive aspects were able to be achieved.

Polymerize the first 35 layers in one exposure (reducing the overall time of a print and adhering the device to the slide);

Polymerize the second set of 35 layers using the same settings except reducing the exposure time as this section is being attached to the previous layer which is polymer; and/or Use dimming on the outer edges of the first layer and maintain tolerances.

Current Applicant furthered this technique by using a second filter for transition layers, from 70-100, by way of example. In this segment, Applicant through testing reduced the number of pixels being used by the burn-in layers, and the thickness is reduced to 100 using the same filter. These layers are exposed to a time slightly less than the previous layers, in aspects. This accomplishes several items:
Polymerize the several sets of 10-layer segments with the same filter setting except reduce the exposure time as this section is being attached to the previous layer which is polymer; and
Maintain tolerances for the final transition of 300 um.

While this technique cannot be used in every layer to skip portions of a device, it can be programmed into the slicing engine which would recognize when to use this technique or patterns and have a library look-up exposure/filter combinations to use as it compares areas of several layers. In the subsequent layers, which can be termed “normal,” an algorithm can be used which maintains the exterior walls at a higher brightness while keeping the interior dim. This allows even curing on the process per layer.

In total, the process reduces the time for the device to be printed. It shows that this technique can reduce the print time by, for example, 30% over standard printing techniques, or 10%, 20%, 40%, 50% over stand techniques, and so on. Together with the clip motion time savings, this reduces the time significantly; for example, the new method can be 4-10× faster, or 2× faster, 3× faster, 11× faster, 12× faster, 100× faster, and so on.

This introduces several new techniques:

Exposures can happen in a single layer with the results and crosslinking being tuned between adjacent areas within that one single exposure vs. multiple exposures/previous art, which required double exposures, or more, for the same result.

Two separate exposures can be used with different filters for selected wavelengths which allow for different crosslinking and depth of cure between each separate exposure. This results in a higher tunabilty and fidelity of cross-linking spacially within one layer and controlling the light-bleed, which has the effect of enlarging the walls or lowering the ceiling of a layer, independent of the “layer slice height.”

By taking the difference of all layers from 1-n, and eroding the pixels closest to any edges (not all black), the entire device, across all previously printed layers, can be cured directly on the build plate with a final exposure, without curing the channels, which substantially removes the issue of green-cure stability, as well as reduces post-processing need(s). This is a significant improvement over related art.

In this disclosure of the current invention, in embodiments, the Applicant teaches that before removing the object from the elevator/clip, the printer can use a final exposure in order to further cure the complete model throughout all layers by using a filter that allows light which will pass through the entirety of the model while it is still on the elevator. This final exposure image for exemplary purposes and as used here is a combined image of all the images from layer 0-n, where only a pixel that is non-zero (0 being white, 1 to 254 (gray), and 255 (black)) is activated. In other words, this final image can be envisioned as or known as a “difference image”, where one PNG is layered on a second and third and so on, if a pixel, area, sub-area is black or 0, or 0,0,0 on the RBG scale, it remains so in the final exposure. This final exposure can happen either directly after the final layer is exposed without moving the elevator as no resin needs to be refreshed, or after a peel and reset move where the elevator returns back to the last position for the final layer. Pixel erosion, masking, or a similar technique, may be used to prevent light bleed in the XY plane. Thus, the final cure can be accomplished with targeted light while the device is still on the platform, rather than a global light cure in a box after the device is cleaned. This removes a significant process step, a complete machine from the process, as well as reducing time and complexity of the post cure process.

The above scenarios can be programmed into a slicer and be automatically updated based on layer differences such as total area, area difference, and/or number of layers equal. (See, FIG. 18.)

FIG. 22 illustrates the 3D Printing techniques combined from the above processes and used in proper order, by way of an example.

The current invention includes several Aspects:
Aspect 1. A method of three-dimensionally (“3D”) printing, comprising:
a. providing one or more resin comprising at least one of one or more photoinitiator, one or more photo blocker, one or more monomer, one or more oligomer, one or more plasticizer, or one or more dye;
b. providing projector having a light source;
c. constructing a 3D printed structure by 3D printing one layer at a time;
d. curing each layer of the 3D printed structure using the light source; and
e. providing a bandpass filter between the light source and the resin that allows a chosen segment of a spectrum of the light source to polymerize the resin, which allows for control over the cure depth and thickness of a layer of the 3D structure.
Aspect 2. The method of three-dimensionally (“3D”) printing of Aspect 1, further comprising:
providing at least two bandpass filters, a first bandpass filter and a second bandpass filter; and
using the first bandpass filter for curing a first layer of the 3D printed structure and the second bandpass filter for curing a second layer of the 3D printed structure, wherein using the two different bandpass filters causes the first layer to have a first cure depth, cure rate, dose rate, or combinations thereof, and the second layer to have a second cure depth, cure rate, dose rate, or combinations thereof, such that the first layer has a first thickness and the second layer has a second thickness.
Aspect 3. The method of three-dimensionally (“3D”) printing of Aspect 1, further comprising: changing one or more pixel pitch between two or more exposures from the light source, such that a first cure rate from a first exposure differs from a second cure rate of the second exposure.
Aspect 4. The method of three-dimensionally (“3D”) printing of Aspect 1, wherein the filter is located in or on a shutter.
Aspect 5. The method of three-dimensionally (“3D”) printing of Aspect 1, wherein the light from the light source has a spectrum of wavelengths wide enough to reach beyond the absorption spectrum of the resin.
Aspect 6. The method of three-dimensionally (“3D”) printing of Aspect 1, wherein the photo blocker and the photoinitiator have different absorption levels at different wavelengths of the light from the light source.
Aspect 7. The method of three-dimensionally (“3D”) printing of Aspect 1, wherein absorption levels of the photo blocker and the photoinitiator partially overlap.
Aspect 8. The method of three-dimensionally (“3D”) printing of Aspect 1, wherein both the one or more photo blocker and the one or more photoinitiator do not interact with the chosen segment of the spectrum of the light source, thereby allowing the light from the light source to penetrate the 3D printed structure without causing any curing and reach a camera.
Aspect 9. The method of three-dimensionally (“3D”) printing of Aspect 8, wherein the camera records images of exposures of a plurality of layers of the 3D printed structure.
Aspect 10. The method of three-dimensionally (“3D”) printing of Aspect 8, wherein the camera is connected to a computer processor with logs and/or analyzes at least one of cure rate, dose rate, polymerization, or cross-linking.
Aspect 11. The method of three-dimensionally (“3D”) printing of Aspect 1, wherein the one or more photo blocker, the bandpass filter, and the light sources, provide for a controlled method of polymerization such that cure depths can be selected to fall between at least one of 1-25 um, 20-75 um, 65-150 um, 130-350 um, 300-500 um, 250-1000 um, and 500 um-2500 um.
Aspect 12. The method of three-dimensionally (“3D”) printing of Aspect 1, further comprising providing a computer processing unit and a slicing software program to control at least one of whether a bandpass filter should be used, which bandpass filter should be used, whether a bandpass filter should not be used, or how many layers are printed during a single exposure.
Aspect 13. The method of three-dimensionally (“3D”) printing of Aspect 1, further comprising a computer processing unit providing a decision matrix program to control a slicing engine for deciding pixel size, location of the projector, overlap from one position of the pixel array to the next within a mosaic layer, designing a mosaic framework for a layer, or to achieve a preferred speed or preferred crosslinking of the 3D printed structure.
Aspect 14. The method of three-dimensionally (“3D”) printing of Aspect 1, wherein the 3D printed structure is a microfluidic device comprising at least one of internally-located channels, pillars, inlets, or outlets.
Aspect 15. The method of three-dimensionally (“3D”) printing of Aspect 14, wherein a cross-section of the at least one of the internally-located channels, pillars, inlets, or outlets, are circular or ovular in shape, and are below 300 microns in diameter.
Aspect 16. The method of three-dimensionally (“3D”) printing of Aspect 1, further comprising switching from a first bandpass filter to a second bandpass filter during printing of a single layer to create a texture or roughness to a surface of the single layer, wherein the 3D printed structure is a microfluidic device, and wherein the texture or roughness improves passive mixing of fluids, cells, particles, chemical, reagents, or combinations thereof, to be used in the microfluidic device.
Aspect 17. A three-dimensional (“3D”) printing system comprising:
a. a resin for curing and creating layers for the layer-by-layer 3D printing process;
b. a light source projector, wherein the light source projector is attached to a gantry;
c. the gantry, which is moveable towards and away from the resin in a Z plane, and which is moveable in an X-Y plane for printing patterned layers; and
d. wherein moving the UV light source towards and away from the resin along with moving the UV light source in the X-Y plane allows for printing different pixel sizes at different areas within a single layer of the layer-by-layer 3D printing process, such that a layer of the layers for the layer-by-layer 3D printing process is printed having different pixel sizes at different areas within the same layer.
Aspect 18. The three-dimensional (“3D”) printing system of Aspect 17, further comprising a linear activation mechanism for controlling the gantry, wherein the linear activation mechanism comprises at least one of a lead-screw, a stepper-motor, one or more linear rail, a linear rail, a nano-stage, or a single axis stage.
Aspect 19. A three-dimensional (“3D”) printing apparatus comprising:
a. a build deck allowing for loading and unloading of a printing surface for 3D printing of an object or device;
b. one or more clip having a thickness ranging from 0.15 mm to 0.5 mm;
c. one or more spring for at least one of spring-activated locating of the printing surface, allowing for a repeatable location of the printing surface, spring-activated leveling of the build deck, spring-activated locking of the printing surface and the build deck, or spring-activated removal of the object or the device being 3D printed without having to remove the build deck; and
d. one or more gantry located between an elevator and the build deck, wherein the one or more gantry has at least one axis of motion.
Aspect 20. The three-dimensional (“3D”) printing apparatus of Aspect 19, wherein the 3D printing apparatus prints the object or the device within a range of resolution between 0.2 um and 50 um.
Aspect 21. A method of projector autofocus in three-dimensional printing providing for multiple pixel pitch and multiple mosaic layering, the method comprising:
a) providing a projector comprising a projector lens, wherein the projector is attached to one or more Z axis gantry;
b) automatically focusing of the projector lens for pixels between 0.1 um and 100 um;
c) providing at least one of a stepper motor or a servo motor that interfaces with the one or more Z axis gantry;
d) providing at least one of a bevel, a spur gears, set of screws, a hollow screw-set or a belt, or a linear activator, to activate the automatically focusing of the projector lens;
e) using a linear rail to adjust a zoom of the projector lens;
f) moving the projector as oriented relative to a vat window or a resin surface within a range between a first position wherein the projector lens is in contact with the bottom of the vat window or the resin surface and a second position 1 meter lower relative to the vat window or resin surface;
g) allowing for adjusting the first position or the second position of the projector lens during operation of a three-dimensional printing process.
Aspect 22. The method of Aspect 21, further comprising providing a computer processing unit, wherein the computer processing unit controls the location of the projector as oriented relative to the vat window or the resin surface within the range from the first position to the second position.
Aspect 23. A shutter for a three-dimensional (“3D”) printing apparatus comprising at least one filter and a light source from a projector;
wherein the shutter has two or more positions;
wherein a first position of the two or more positions applies a filter to the light source;
wherein a second position of the two or more positions applies a second filter to the light source, or wherein the second position blocks the light source or allows light from the light source to freely pass; and
wherein the shutter uses a first shutter position for a first exposure and uses a second shutter position for a second exposure, wherein the second exposure can be one of the same as the first exposure, different than the first exposure, or polymerize the same or similar pixels or voxels as the first exposure.
Aspect 24. The shutter for a three-dimensional (“3D”) printing apparatus of Aspect 23, wherein a first position of the at least two or more positions apply a first filter during a first layer of 3D printing and a second position of the at least two or more positions applies a second filter during a second layer of 3D printing.
Aspect 25. The shutter for a three-dimensional (“3D”) printing apparatus of Aspect 23, wherein two positions of the at least two or more positions use two different filters for a same layer.
Aspect 26. The shutter for a three-dimensional (“3D”) printing apparatus of Aspect 23, wherein changing between the at least two or more positions causes a change in a surface roughness of an internal cavity of the object being 3D printed.
Aspect 27. The shutter for a three-dimensional (“3D”) printing apparatus of Aspect 23, further comprising a computer processor having a CAD drawing setting, resin profile, or slicing setting, including a texture or roughness level, which selects the texture or roughness level and applies the texture or roughness level to internal surfaces of the object being 3D printed.
Aspect 28. The shutter for a three-dimensional (“3D”) printing apparatus of Aspect 23, wherein the shutter is servo-controlled.
Aspect 29. The shutter for a three-dimensional (“3D”) printing apparatus of Aspect 23, wherein the at least one filter comprises at least one of colored glass, a bandpass filter, or an optical filter.

Embodiments of the invention also include a computer readable medium comprising one or more computer files comprising a set of computer-executable instructions for performing one or more of the calculations, steps, processes, and operations described and/or depicted herein. In exemplary embodiments, the files may be stored contiguously or non-contiguously on the computer-readable medium. Embodiments may include a computer program product comprising the computer files, either in the form of the computer-readable medium comprising the computer files and, optionally, made available to a consumer through packaging, or alternatively made available to a consumer through electronic distribution. As used in the context of this specification, a “computer-readable medium” is a non-transitory computer-readable medium and includes any kind of computer memory such as floppy disks, conventional hard disks, CD-ROM, Flash ROM, non-volatile ROM, electrically erasable programmable read-only memory (EEPROM), and RAM. In exemplary embodiments, the computer readable medium has a set of instructions stored thereon which, when executed by a processor, cause the processor to perform tasks, based on data stored in the electronic database or memory described herein. The processor may implement this process through any of the procedures discussed in this disclosure or through any equivalent procedure.

In other embodiments of the invention, files comprising the set of computer-executable instructions may be stored in computer-readable memory on a single computer or distributed across multiple computers. A skilled artisan will further appreciate, in light of this disclosure, how the invention can be implemented, in addition to software, using hardware or firmware. As such, as used herein, the operations of the invention can be implemented in a system comprising a combination of software, hardware, or firmware.

Embodiments of this disclosure include one or more computers or devices loaded with a set of the computer-executable instructions described herein. The computers or devices may be a general purpose computer, a special-purpose computer, or other programmable data processing apparatus to produce a particular machine, such that the one or more computers or devices are instructed and configured to carry out the calculations, processes, steps, operations, algorithms, statistical methods, formulas, or computational routines of this disclosure. The computer or device performing the specified calculations, processes, steps, operations, algorithms, statistical methods, formulas, or computational routines of this disclosure may comprise at least one processing element such as a central processing unit (i.e., processor) and a form of computer-readable memory which may include random-access memory (RAM) or read-only memory (ROM). The computer-executable instructions can be embedded in computer hardware or stored in the computer-readable memory such that the computer or device may be directed to perform one or more of the calculations, steps, processes and operations depicted and/or described herein.

Additional embodiments of this disclosure comprise a computer system for carrying out the computer-implemented method of this disclosure. The computer system may comprise a processor for executing the computer-executable instructions, one or more electronic databases containing the data or information described herein, an input/output interface or user interface, and a set of instructions (e.g., software) for carrying out the method. The computer system can include a stand-alone computer, such as a desktop computer, a portable computer, such as a tablet, laptop, PDA, or smartphone, or a set of computers connected through a network including a client-server configuration and one or more database servers. The network may use any suitable network protocol, including IP, UDP, or ICMP, and may be any suitable wired or wireless network including any local area network, wide area network, Internet network, telecommunications network, Wi-Fi enabled network, or Bluetooth enabled network. In one embodiment, the computer system comprises a central computer connected to the internet that has the computer-executable instructions stored in memory that is operably connected to an internal electronic database. The central computer may perform the computer-implemented method based on input and commands received from remote computers through the internet. The central computer may effectively serve as a server and the remote computers may serve as client computers such that the server-client relationship is established, and the client computers issue queries or receive output from the server over a network.

The input/output interfaces may include a graphical user interface (GUI) which may be used in conjunction with the computer-executable code and electronic databases. The graphical user interface may allow a user to perform these tasks through the use of text fields, check boxes, pull-downs, command buttons, and the like. A skilled artisan will appreciate how such graphical features may be implemented for performing the tasks of this disclosure. The user interface may optionally be accessible through a computer connected to the internet. In one embodiment, the user interface is accessible by typing in an internet address through an industry standard web browser and logging into a web page. The user interface may then be operated through a remote computer (client computer) accessing the web page and transmitting queries or receiving output from a server through a network connection.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

As used herein, the term “about” refers to plus or minus 5 units (e.g., percentage) of the stated value.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

As used herein, the term “substantial” and “substantially” refers to what is easily recognizable to one of ordinary skill in the art.

It is to be understood that the phraseology and terminology employed herein is not to be construed as limiting and are for descriptive purpose only.

It is to be understood that while certain of the illustrations and figures may be close to the right scale, most of the illustrations and figures are not intended to be of the correct scale.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

1. A three-dimensional (“3D”) printer comprising:
one or more a light source providing light having a spectrum with a bandwidth that interacts with a resin;
one or more digital micromirror device (“DMD”) comprising one or more mirror to spatially direct the light from the light source;
one or more focusing lens to focus pixels from the one or more mirror at a plane of polymerization;
one or more filter, wherein the one or more filter narrows the spectrum of light from the light source, and wherein the one or more filter is located between the light source and a vat or resin container and
the vat or resin container holding the resin, the resin comprising one or more photoinitiator, wherein the one or more photoinitiator is reactive with at least a portion of the spectrum of light from the light source, and wherein the vat or resin container comprises one or more substantially transparent window.

2. The 3D printer of claim 1, further comprising a build deck attached to an elevator, the build deck comprising a clip for holding a slide, wherein the elevator changes position to refresh the resin between each one or more layer of polymerization, and wherein a 3D printed structure can be printed directly on the slide.

3. The 3D printer of claim 1, further comprising a non-transitory computer readable medium comprising program instructions that, when executed by at least one processor, cause the at least one processor to perform a method to control an order of steps for 3D printing, a duration of an exposure, a motion and layer height for the steps, or combinations thereof, for 3D printing using the 3D printer.

4. The 3D printer of claim 1, further comprising a non-transitory computer readable medium comprising program instructions that, when executed by at least one processor, cause the at least one processor to perform a method to derive a series of images from a 3D model, the processor operative to select one or more images from the series of images, and the processor operative to display the one or more images at different times and/or heights of the 3D print.

5. The 3D printer of claim 1, wherein the filter is static or wherein the filter is moveable from one position to another.

6. The 3D printer of claim 1, wherein the one or more filter allows for changing or selecting a range of wavelengths.

7. The 3D printer of claim 1, wherein the one or more light source comprises at least two different light sources, and wherein switching which light source is activated allows for changing or selecting a range of wavelengths.

8. The 3D printer of claim 1, wherein changing the one or more light source to a different one or more light source during a 3D print allows curing at different rates, different thicknesses, different exposure times, or combinations thereof, allowing for printing variable layer heights in a single exposure.

9. The 3D printer of claim 1, wherein changing the one or more filter to a different one or more filter during a 3D print allows curing at different rates, different thicknesses, different exposure times, or combinations thereof, allowing for printing variable layer heights in a single exposure.

10. A light apparatus for three-dimensional (“3D”) printing comprising:
an irradiation source which may be one or more of:
a light emitting diode (“LED”) having a wavelength in a range between 265 nm and 800 nm;
an LED array comprising a plurality of LEDs having different wavelengths, the wavelengths being in a range between 265 nm and 800 nm;
one or more standard projector light bulb having a wavelength in a range between 265 nm and 800 nm;
one or more standard Mercury bulb;
one or more Arc Lamp;
one or more Cadmium bulb; and
one or more laser having a wavelength in a range between 265 nm and 800 nm;
a digital micromirror device (“DMD”) or DMD array;
one or more filter to narrow or alter an originating spectrum of light from the irradiation source that interacts with a polymerization zone or a working area of a 3D printer; and
one or more optionally tunable optic enabling one or more pixel to focus to between 0.2 um and 50 um at the polymerization zone or the working area of the 3D printer.

11. The light apparatus of claim 10, wherein a final pixel pitch of a 3D print using the light apparatus is tunable by adjusting (a) a position of a build deck comprising the light apparatus, (b) an elevator comprising the build deck, (c) a focus of the one or more optionally tunable optic, (d) the one or more filter, (e) a distance between the light apparatus and the polymerization zone or the working area, or combinations thereof.

12. The light apparatus of claim 10, wherein the one or more filter is located between: (a) the irradiation source and the DMD or DMD array, (b) the DMD or DMD array and the one or more optionally tunable optic, (c) the one or more optionally tunable optic and the polymerization zone or the working area, or (d) the one or more optionally tunable optic and a polymerization plane.

13. The light apparatus of claim 10, wherein the one or more filter reduces the originating spectrum of light from the irradiation source to a 10 nm width.

14. The light apparatus of claim 10, wherein the one or more filter reduces the originating spectrum of light from the irradiation source to a bandgap having widths in a range from 265 nm to 420 nm.

15. The light apparatus of claim 10, wherein the one or more filter is one or more bandpass filter and/or one or more colored glass, wherein the one or more filter narrows the originating spectrum of light from the irradiation source to a spectrum of light having a spectrum between 260 nm and 1000 nm.

16. The light apparatus of claim 10, wherein the light apparatus is capable of creating one or more image, a series of images, a movie, a motion picture, a motion of several images in series, or combinations thereof, for 3D printing within a single layer of a multi-layered 3D printed structure.

17. The light apparatus of claim 10, wherein the light apparatus includes at least two filters, and wherein using a first filter of the at least two filters cures a resin of a first 3D printed layer to a first thickness, and wherein a second filter of the at least two filters cures a resin of a second 3D printed layer to a second thickness; or wherein the one or more filter is removed for 3D printing one or more layers in a multi-layered 3D structure.

18. A computer-implemented method of three-dimensionally (“3D”) printing, comprising:
a. using one or more resin comprising one or more photoinitiator, one or more photoabsorber, one or more photo blocker, one or more monomer, one or more oligomer, one or more plasticizer, one or more dye, or combinations thereof;
b. using a light source, wherein at least a portion of a spectrum of light from the light source is reactive with the resin;
c. using a non-transitory computer readable medium comprising program instructions that, when executed by at least one processor, cause the at least one processor to perform a method to:
i. divide and/or slice a 3D model into individual Z-axis segments and/or layers of equal thickness;
ii. compare an XY-plane first segment and/or layer to a second XY-plane segment and/or layer based on (a) a percentage difference in pixels between the XY-plane first segment and/or layer and the second XY-plane segment and/or layer, (b) a difference in pixel brightness between the XY-plane first segment and/or layer and the second XY-plane segment and/or layer, (c) a number of overlapping pixels between the XY-plane first segment and/or layer and the second XY-plane segment and/or layer, or combinations thereof, wherein the comparison results in grouping of adjacent XY-plane segments and/or layers in a Z-axis that are substantially similar or identical, into two or more XYZ-volumes;
iii. select no filter, or select a filter of one or more filter located between the light source and the one or more resin, wherein changing the filter from a first filter to a second filter, or selecting no filter, provides for control over a spectrum of light and/or a segment of a spectrum of light from the light source that polymerizes the one or more resin, which allows for control over a cure depth and a cure thickness of one or more layer of the 3D printed structure; and
iv. convert each XYZ-volume of the two or more XYZ-volumes into an exposure time based on a total Z-axis thickness of the XYZ-volume and based on the selection of no filter or a filter of the one or more filters.

19. The computer-implemented method of three-dimensionally (“3D”) printing of claim 18, wherein the light source comprises one or more of:
a light emitting diode (“LED”) having one or more of the following wavelengths: 365 nm, 375 nm, 380 nm, 385 nm, 395 nm, 405 nm, or any wavelength within a range of 325 nm to 800 nm;
an LED array having one or more of the following wavelengths: 365 nm, 375 nm, 380 nm, 385 nm, 395 nm, 405 nm, or any wavelength within a range of 325 nm to 800 nm;
one or more standard projector light bulb having one or more of the following wavelengths: 365 nm, 375 nm, 380 nm, 385 nm, 395 nm, 405 nm, or any wavelength within a range of 325 nm to 800 nm;
one or more standard Mercury bulb;
one or more Cadmium bulb; and
one or more laser having one or more of the following wavelengths: 365 nm, 375 nm, 380 nm, 385 nm, 395 nm, 405 nm, or any wavelength within a range of 325 nm to 800 nm.

20. The computer-implemented method of three-dimensionally (“3D”) printing of claim 18, further comprising: changing one or more pixel pitch within a Z-axis segment and/or layer of the 3D printed structure while 3D printing the 3D printed structure, or changing one or more pixel pitch within a Z-axis segment and/or layer of the 3D printed structure between two or more exposures from the light source during 3D printing of the 3D printed structure, such that a first cure rate from a first pixel pitch or a first exposure differs from a second cure rate of a second pixel pitch or a second exposure.

21. The computer-implemented method of three-dimensionally (“3D”) printing of claim 18, wherein changing one or more pixel pitch at a plane of polymerization or exposed area while printing two or more Z-axis segments and/or layers of the 3D printed structure, or changing one or more pixel pitch at the plane of polymerization or the exposed area between two or more exposures from the light source while printing two or more Z-axis segments and/or layers of the 3D printed structure, allows for adjusting resolution in an XY plane, which allows for printing an individual Z-axis segment and/or layer with features having different thickness and/or feature (XY) resolution.

22. The computer-implemented method of three-dimensionally (“3D”) printing of claim 18, further comprising providing different pixel pitches at a plane of polymerization or exposed area to create different cured areas in a same layer of the 3D printed structure, wherein a first area in the same layer is created by a first pixel pitch and a second area in the same layer is created with by a second pixel pitch.

23. The computer-implemented method of three-dimensionally (“3D”) printing of claim 18, wherein two different filters of the one or more filter are used at different times during the 3D printing to expose all or part of a Z-axis segment and/or layer image, or wherein a filter of the one or more filter is used for at least part of the 3D printing and no filter is used during at least another part of the 3D printing to expose all or part of a Z-axis segment and/or layer image, to 3D print a same layer of the 3D printed structure.

24. The computer-implemented method of three-dimensionally (“3D”) printing of claim 18, wherein different portions of a same Z-axis segment and/or layer are exposed to light from the light source filtered by two different filters of the one or more filter, causing the different portions to have different cure depths and/or cross-linking properties.

25. The computer-implemented method of three-dimensionally (“3D”) printing of claim 18, wherein the selection of the one or more filter is based at least in part on a spectrum of originating light from the light source, and wherein the selection of the or more filter based at least in part on the spectrum of originating light from the light source is to cause an increase in cross-linking of resin forming smooth walls of channels in the 3D printed structure, while still leaving voids in the 3D printed structure which allow uncured resin to be removed.

26. The computer-implemented method of three-dimensionally (“3D”) printing of claim 18, wherein changing from one filter to another filter allows for (a) different depth of cure, and/or (b) multiple Z-axis segments and/or layers to be printed simultaneously.

27. The computer-implemented method of three-dimensionally (“3D”) printing of claim 18, wherein light from the light source has a spectrum of wavelengths wide enough to reach beyond an absorption spectrum of the one or more photoabsorber and the one or more photoblocker.

28. The computer-implemented method of three-dimensionally (“3D”) printing of claim 18, wherein using two different filters during 3D printing of a single Z-axis segment and/or layer of the 3D printed structure, or using a filter during one part of 3D printing of a single Z-axis segment and/or layer of the 3D printed structure and using no filter during another part of 3D printing the same single Z-axis segment and/or layer of the 3D printed structure, creates a texture or a roughness to a surface of the single Z-axis segment and/or layer.

29. The computer-implemented method of three-dimensionally (“3D”) printing of claim 18, further comprising printing multiple Z-axis segments and/or layers of the 3D printed structure in a single exposure from the light source.

30. A three-dimensionally (“3D”) printed microdevice comprising multiple layers of cured resin, wherein exposures from a light source are used to cure either in full or in part individual layers of the 3D printed microdevice, wherein at least one filter is provided between the light source and a plane of polymerization, the at least one filter operative to attenuate and/or change an originating spectrum of light from the light source, wherein attenuating and/or changing the originating spectrum of light from the light source between a first layer and a second layer while 3D printing the 3D printed microdevice results the first layer having different physical properties from the second layer.

31. The 3D printer of claim 1, wherein light from the light source includes two or more wavelengths simultaneously projected through the one or more filters, wherein the two or more wavelengths are operative to cause different cure depths in a same exposure event, allowing for volumetric printing of a region of resin in a single exposure.

32. The 3D printer of claim 1, wherein the one or more light source is operable to emit multiple wavelengths simultaneously or sequentially through different filters, wherein each wavelength is matched to a photoinitiator having a chosen absorption spectrum, thereby enabling polymerization across multiple vertical depths within a resin volume during one or more exposures.

33. The 3D printer of claim 31, wherein the light source is operable to emit two or more light wavelengths, each light wavelength of the two or more light wavelengths selected to activate one or more photoinitator of two or more photoinitiators, wherein each photoinitiator of the two or more photoinitiators have different optical absorption coefficients, such that exposure of the resin to the two or more light wavelengths is configured to result in polymerization at different spatial depths within a single exposure cycle, thereby enabling volumetric curing and in-layer depth control.
